(19) United States
(12) Patent Application Publication
(10) Pub. No.: US 2010/0268705 A1
(43) Pub. Date: Oct. 21, 2010

(54) DATABASE AND DATA ACCESS LAYER

(76) Inventors: David Douglas, Hertfordshire (GB); Lawrence James Brotherton, Hertfordshire (GB)

Correspondence Address: Thomas M. Galgano, 20 W. Park Avenue, Suite 204, Long Beach, NY, 11561, US

(21) Appl. No.: 12/626,720

(22) Filed: Nov. 27, 2009

(30) Foreign Application Priority Data
Mar. 13, 2009 (GB) GB0904414.0

(51) Int. Cl. G06F 17/30

(52) U.S. Cl. 707/723; 707/802; 707/E17.005

(57) ABSTRACT

The system of the present invention facilitates the collection, processing, optimization and communication of data. Project data is accessed through an architecture, comprising an access layer, with programs for retrieving, processing and communicating data from a database, and a Customer User Interface (CUI) presentation layer. The CUI provides individual users with interaction throughout the project life-cycle, for example, for recording and processing information, completing project tasks, producing and managing documents, managing changes, issues and risks and producing reports and business intelligence, including individual project and projects portfolio status indicators.

This invention relates to a system for project management and business information.

### BACKGROUND OF THE INVENTION

For most companies in the race for a competitive edge, technological projects have become the largest single capital expenditure accompanied by the biggest risk, particularly for companies delivering new technology to their customers. Recent research figures indicate that up to 68% of projects are delivered late, over budget, under-perform or are abandoned.

There are many reasons for a project failing which include, the technology not being fit for purpose, poor management structures, a lack of end to end project governance, inadequate project resource, processes, sponsorship, ownership, transparency and a change to business strategy.

All too often initiated projects are left to operate in a vacuum as many business sponsors have little time, understanding or visibility of the project needs, until it is too late for the project. More often than not, the right questions are not being asked of the team implementing a project, or by the customer's team, concerning what is required of a project and how to measures project success, value and risk.

Additionally, the system being used to control the project may not be designed for purpose or be too complex to use efficiently.

The present invention facilitates project definition and planning, document production and action-driven processes, using a template-based approach. Any number of templates may be defined and saved for subsequent use, using the systems administration software facilities. The definition of multiple templates may then be applied to different industry sectors, or made available to different companies within an industry sector, or used to support the introduction of different products, or project implementation approaches, within a single company.

As well as templating the overall project implementation process, individual documents or process instructions within the process can also be templated. The document templates are then stored within a document library, which can be accessed by users.

Additionally, the invention facilitates the subsequent project management activities for the full project lifecycle, for example, task completion, change requests, risk, issue and action management and progress monitoring and reporting. The storing of all project activities, and the availability of real-time status information, within a single database, facilitates the production of numerous levels of business information and statistics—known within the invention as Business Insight.

The internal system structure consists of four functional software sub-systems; 1) a maintenance software suite that allows the owner to configure and administer the system services, 2) a subscriber software suite that allows the subscribed users to access the system facilities, 3) security software that authenticates all access requests to the system and defines the appropriate screen and data content to be displayed to individual users and 4) integration between the system and a public internet website, for users to register interest, receive information and subscribe to the service.

### SUMMARY OF THE INVENTION

Summary of Invention

In accordance with an aspect of the invention there is provided an apparatus. The apparatus is in a system including at least one database, one of which is configured to store one or more templates, and a user device including a user interface for receiving user input. The apparatus comprises means to retrieve at least one of the one or more templates from the at least one database, in response to user input into the user device, a first output to transmit the retrieved template to the user device, an input to receive an adapted template from the user device, the adapted template comprising the template and user input, and a second output to transmit the adapted template to one of the at least one databases.

In this way a user can selectively amend templates that are available on a system and store them for later reference or use.

The template may be a project template, the project template defining a project including project phases and tasks, the amended project template comprising project phases and tasks selected according to the user input. In this way a user can readily build a project including predefined stages. This makes building the project more efficient as standard parts of the project will not need to be built from scratch.

A project phase is a section of the project containing tasks which relate to one part of the project. Tasks are parts of the project which need to be completed. For example, they may include creation of a project plan, authoring a document or the installation of a piece of equipment.

Optionally, the user may be able to determine how data, either in the template or user input data is segregated into the different phases of a project.

A phase or a task may be assigned a weighting. The weighting is preferably correlated with the importance of the phase or task. The weighting enables the user device to prioritise the display of information for the phase or task thereby enabling optimization of the allocation and subsequent utilisation of scarce resources.

Preferably the weighting of the task or phase is related to: how long the task and/or phase is overdue, the task and/or phase having the most outstanding work, the value of the task and/or phase to the project, the task and/or phase contributing the most to project gross profit or being of greatest customer value.

Advantageously the amended template is stored in one of the at least one databases such that the retrieval component can retrieve the amended template in response to user input into the user device. This enables, for example, a user to modify an amended template for a further project they wish to implement or another customer to use an amended template when they are implementing a similar project.

Preferably, a phase comprises one or more quality gate checkpoints, each quality gate checkpoint being configured to control completion of the phase dependent upon a) each individual task within a phase being completed and b) outputs created during each task being accepted. This means that a project phase cannot be marked complete if it has not been completed to a satisfactory standard.

A document template may include pre-defined paragraph titles, in the form of a Table of Contents. In addition to mandatory sections a document template may also have optional sections which the apparatus does not require user input for.

Documents created using document templates may be stored in, and subsequently accessed from, a document library within one of the databases. A copy of a document template or an existing document can be retrieved from the database and presented within the user interface as the basis to create a new document template or a project document.

The user may select which of the available methods, for example utilising a generic document template defined within the project or selecting a document from another project, to use for creating a new document and then utilises the editing sub-system to complete the production and storage of the new document. For example, a user may choose to edit the Table of Contents and/or the document paragraphs, through the use of a HTML text editor, and save the document to the database.

Optionally, the version number for the issue of a new document may be set and the version number for an amended document incremented automatically, by the apparatus, and recorded within the database.

Advantageously, the apparatus only enables the next phase to be implemented when the quality gate checkpoint for the preceding phase has been completed. This enables a project manager to ensure that each phase of the project has a satisfactory outcome prior to allowing the next phase to begin.

The apparatus is, preferably, configured to process data received from user interfaces and project data, the apparatus is configured to transmit project data to the user device. Project data is configured to cause a graphical display of the components of a project phase, a task or a quality control gate on the user interface of the user device.

Project data may include data representing at least one of a) a project phase, b) task detail and c) a task deliverable. As discussed previously, a project phase is a section of the project containing tasks which relate to one part of the project each task relating to a part of the project which needs to be completed. The task detail is preferably, a task descriptor and instructions detailing the method for carrying out a task. The task deliverable is preferably, the resultant output when a task has been completed successfully.

The graphical display of the project data includes data representing the progress of process workflow and document production, for multiple projects, using coloured indicators. The coloured indicators have separate colours indicating that the process phase not started, a task is in process, a task is on time, a task is suffering delay and the target date has not been met. For example, the coloured indicators may be: white, process phase not started; blue, task in process; green, task on time; amber, tasks is suffering delay; or red, planned date exceeded/threat to the project completion.

Optionally, one of the templates may be a document template. A document template may contain text and/or inserted data objects, such as diagrams, images, photographs or other binary content. The document template may comprise a plurality of sections, one or more of the plurality of sections being a mandatory section, the apparatus being configured to ensure that the mandatory section is completed in the amended template before transmitting the amended output to one of the databases. This enables control over the document to be exerted to ensure that necessary data can be collected.

The document template may also comprise a number of alternative sections. The apparatus being further configured to receive initial user input and retrieve one or more or the alternative sections of the document template in response to receiving initial user input. This enables a customised text document to be provided to the user preventing retrieval, transmission and display of unnecessary data.

Advantageously, the document includes a section which is configured to receive intelligent data. The apparatus, upon recognising intelligent data being configured to automatically copy the intelligent data between one or more documents and/or project phases in the project. This enables there to be a consistency of data between the devices. It also enables data to be gathered more efficiently as certain bits of data, for example, addresses, need only be collected once but will be distributed to all the necessary places in the project.

The project template may pre-assign tasks to each of the phases in a project. Optionally, each project template may also have pre-defined implementation phases and associated tasks stored within the database.

The tasks and/or phases may be separate, interrelated, overlapping or dependent upon each other. For example: tasks within a phase may have no specified or logical order of completion; may follow each other in a serial fashion, such that a task cannot start until the preceding task is fully complete; or may require that any given task cannot start until one or more tasks from the same, or any other phase, is fully complete.

The project data may further include data causing the user interface to display menu bars, above the graphical display, the menu bars enabling direct navigation to all screens within the system. The user interface may further be arranged to display information for multiple projects in a three-level hierarchy, consisting of Organisation, Programme, the projects assigned to an Organisation, and Project.

Optionally, the progress of process workflow and document production, for multiple projects, may be presented on a single screen of the user interface, using coloured indicators. The coloured indicators may be displayed in patterns that relate to the quality gate checkpoint.

Each individual user may be allocated a unique identity, consisting of a User ID and password, for the purposes of logging on to the system via a user interface. Each individual user identity may be assigned one or more project role(s) or one or more system administration role(s). The individual user's unique identity and the assigned project or system administration role(s) may be used, in combination, to determine the details to be made available to that user via the user interface.

The allocation of User ID's and associated passwords may be administered by a special subscriber organisation role known as the Lead Contact. Optionally, the subscriber organisation Lead Contact may create and subsequently grant login ID's for additional (subscriber) organisation personnel to access the system, as well as providing selected customer and supplier organisation personnel, who are associated with project deliverables or equipment/service supplies, access to the system. Customer and supplier organisations will also have an equivalent ‘lead’ contact role, known as the ‘Lead Customer’ or ‘Lead Supplier’, respectively.

Optionally, specified database items are only presented to certain user roles, under different item titles. For example, the separation of the Issues database items into Project Issues for display to Project Team user roles, Software Issues for display to System Administration user roles and Known Issues for display on the internet website.

The current log-in status (i.e. online or offline) of project team members may be made available, to the appropriate project, programme or organisation level work group. This may, for example, be determined by the apparatus determining which user ids are logged on to the apparatus.

Optionally, a limited-audience Instant Messaging System is offered between logged-in users. The Messaging System may be restricted to users having only a certain roles, for example Project Manager or Team Leader, or only allow communication between users involved in common projects.

Data may be imported and exported in pre-defined electronic file formats, for example Microsoft Project™ files.

Each project may have associated with it: project risks, issues, actions and change requests and their associated details. Each of may be part of a project template or created using user input and stored within a database linked to the project using any suitable means. The apparatus may require each of project risks, issues, actions and change requests to be completed along with one or more of the pre-defined tasks the project risk, issue, action or change request is associated with for the next task to be implemented.

Optionally, each of project risks, issues, actions and change requests must be completed along with a quality gate checkpoint the project risk, issue, action or change request is associated with, to enable completion of the associated quality gate checkpoint and the next phase to be implemented.

A change of status for a task may be recorded in the database whenever a task is indicted, by a user, to be complete.

The apparatus may monitor the status of project tasks over a pre-defined time interval (known as the Reporting Period) and any changes in the task status used to compile automated project progress reports.

Optionally, a single report generator is used to request all reports, by way of selection from a drop-down list of available reports and the input of range criteria, for example ‘from’ and ‘to’ dates.

Optionally, the user interface may be a web-browser and the apparatus may be accessed using the world wide web.

The database, apparatus and user device may all be the same device or, alternatively, one or more of the database, apparatus and user device may be implemented on separate pieces of apparatus. Additionally, all of the databases may be present on a single device or may be a distributed system.

Further, it is preferable that the system is scalable, such that multiple projects and multiple users can access the system.

### BRIEF DESCRIPTION OF THE DRAWINGS

Other aspects and features of the present invention will become apparent to those ordinarily skilled in the art upon review of the following description of specific embodiments of the invention in conjunction with the accompanying figures. FIGS. 1 & 2 show the system architecture, FIGS. 3 to 46 relate to the subscriber software suite that allows the subscribed users to access the system facilities, FIGS. 47 to 55 relate to the maintenance software suite that allows the owner to configure and administer the system services and FIGS. 56 and 57 relate to the integration with the public internet site.

FIG. 1 illustrates the operational structure of a system in accordance with the present invention;

FIG. 2 illustrates a user task view displayed on a user interface of the present invention;

FIG. 3 illustrates a project portfolio view displayed on a user interface of the present invention;

FIG. 4 illustrates a project portfolio view showing a multi-site project, as displayed on a user interface of the present invention;

FIG. 5 illustrates a project portfolio archive view as displayed on a user interface of the present invention;

FIG. 6 illustrates an internal project phase view as displayed to a project participant on a user interface of the present invention;

FIG. 7 illustrates an external projects phase view as displayed to a customer on a user interface of the present invention. A similar view is available for supplier organisations participating in projects (not illustrated);

FIG. 8 illustrates a project initiation process phase view as displayed to a project participant on a user interface of the present invention. A similar screen is available for customer and supplier organisations participating in projects;

FIG. 9 is an example of a document (Opportunity Profile document) as displayed on a user interface of the present invention;

FIG. 10 illustrates a project planning process phase view as displayed on a user interface of the present invention;

FIG. 11 illustrates a project design process phase view as displayed on a user interface of the present invention;

FIG. 12 illustrates a project customer approval process phase view as displayed on a user interface of the present invention;

FIG. 13 illustrates a project build and configuration process phase view as displayed on a user interface of the present invention;

FIG. 14 illustrates a project customer handover process phase view as displayed on a user interface of the present invention;

FIG. 15 illustrates a sample Quality Gate view as displayed on a user interface of the present invention;

FIG. 16 illustrates a project team contact view as displayed on a user interface of the present invention;

FIG. 17 illustrates a project report view as displayed on a user interface of the present invention;

FIG. 18 illustrates a risk register as displayed on a user interface of the present invention;

FIG. 19 illustrates a change control log as displayed on a user interface of the present invention;

FIG. 20 illustrates an outstanding actions list as displayed on a user interface of the present invention;

FIG. 21 illustrates a raise a project risk view as displayed on a user interface of the present invention;

FIG. 22 illustrates a raise a project change control view as displayed on a user interface of the present invention;

FIG. 23 illustrates a raise an project issue as displayed on a user interface of the present invention;

FIG. 24 illustrates a raise an project action as displayed on a user interface of the present invention;

FIG. 25 illustrates a create document view as displayed on a user interface of the present invention;

FIG. 26 illustrates a document library view as displayed on a user interface of the present invention;

FIG. 27 illustrates an Instant Messaging view as displayed on a user interface of the present invention; and

FIG. 28 illustrates an administration report generator screen as displayed on a user interface of the present invention;

### DETAILED DESCRIPTION OF PREFERRED EMBODIMENTS

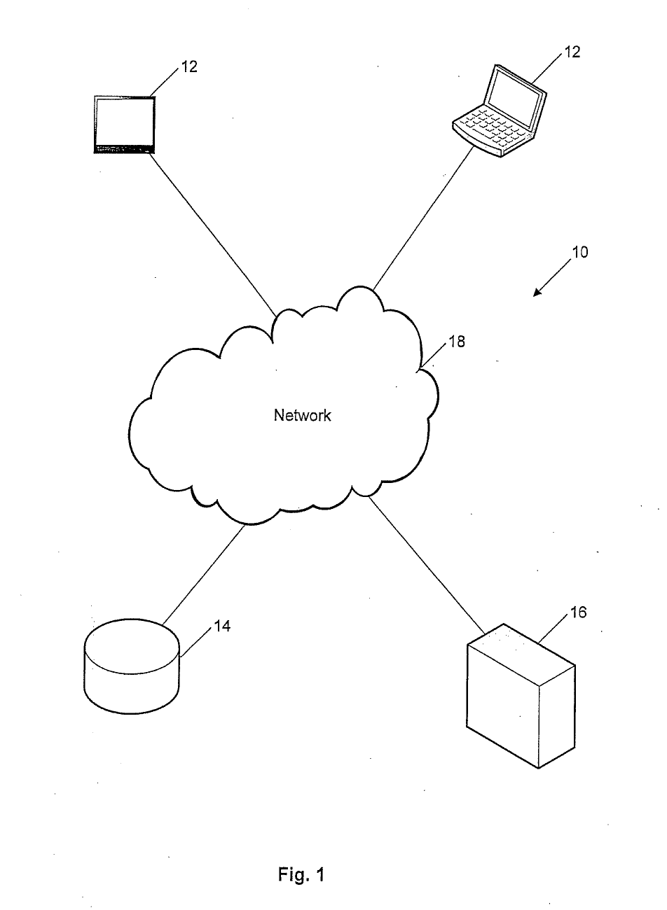

The present invention is a system that facilitates the tracking of projects from conception to delivery. FIG. 1 illustrates an implementation of the system 10 which includes a user interface 12, at least one database 14 and a data access layer (not shown). In the implementation illustrated in FIG. 1 the data access layer is situated on a server 16 and the user interfaces 12, database 14 and server 16 are connected through a network 18 which may be a LAN or a WAN. The network may also be wired or wireless. As the skilled person will understand any suitable configuration may be used to implement the invention. For example, the user interface, database and data access layer may be present on the same apparatus. Alternatively, the database and data access layer may be collocated on an apparatus remote from the user interface. The user interface may, for example, be a web portal. Any other suitable configuration may be used.

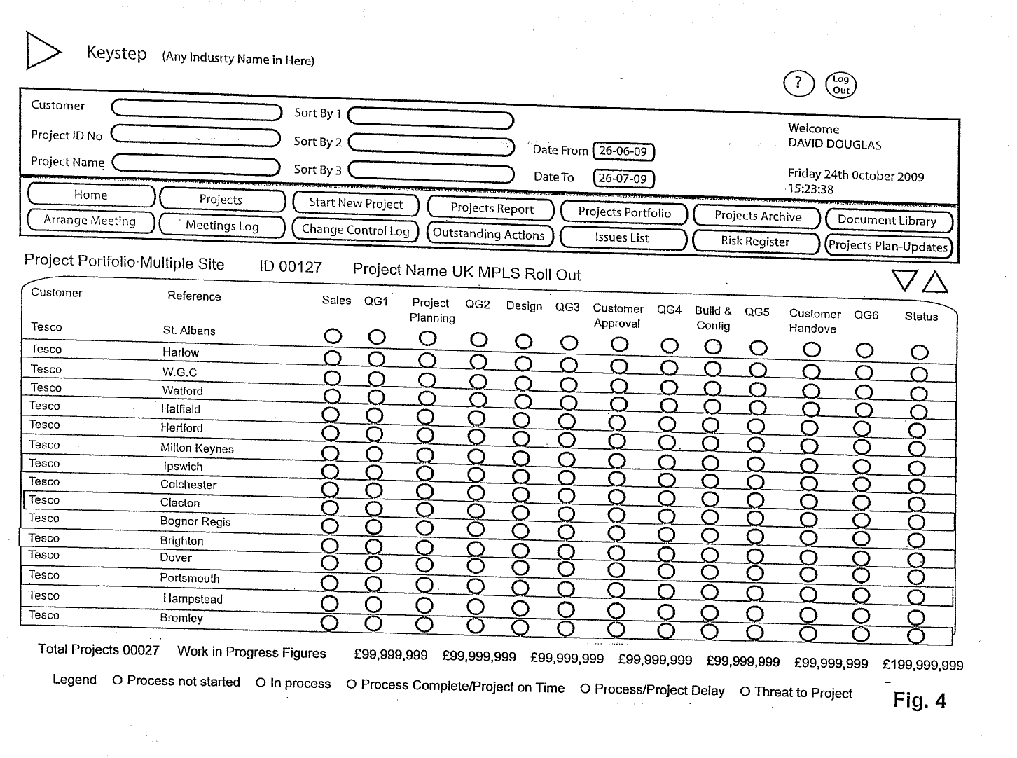

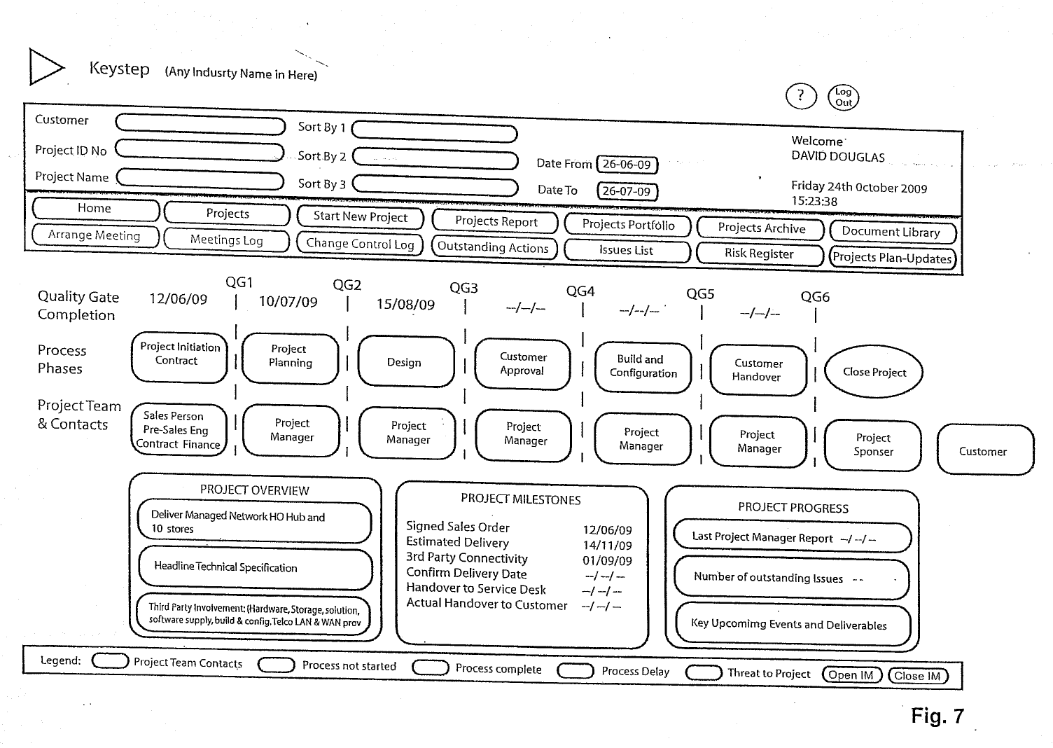

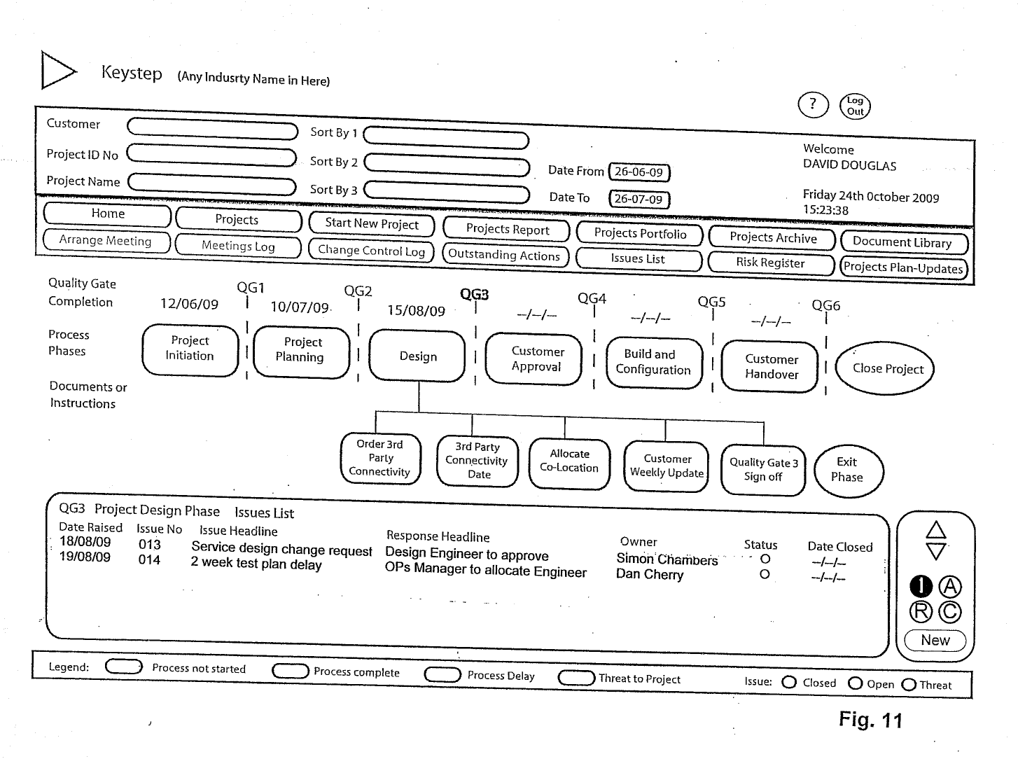

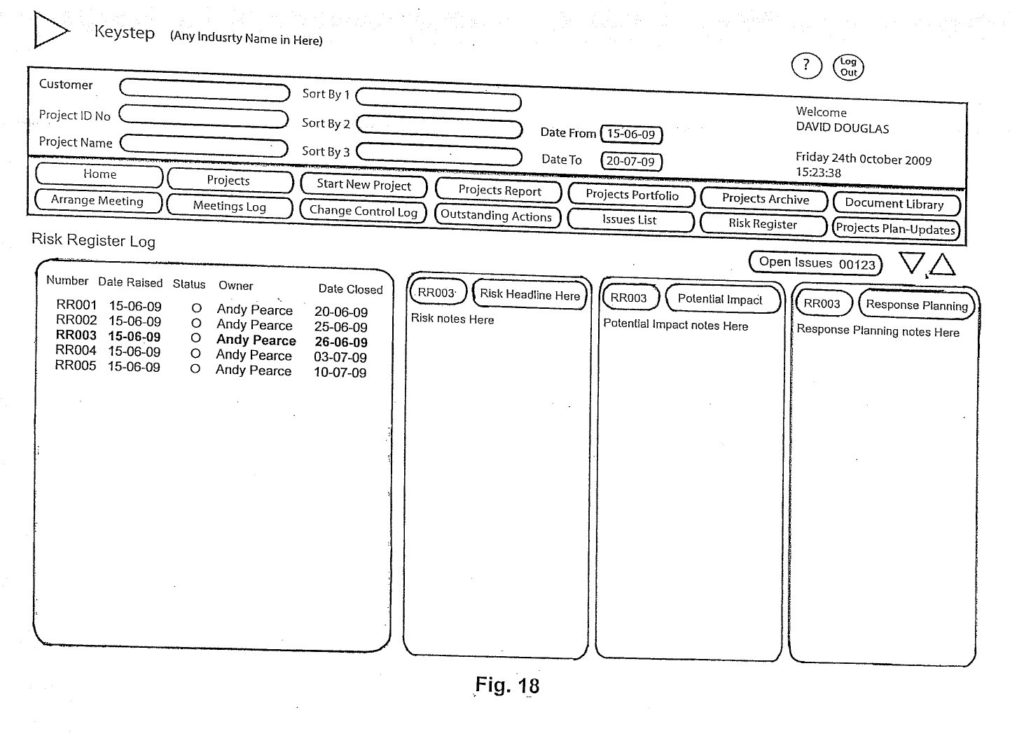

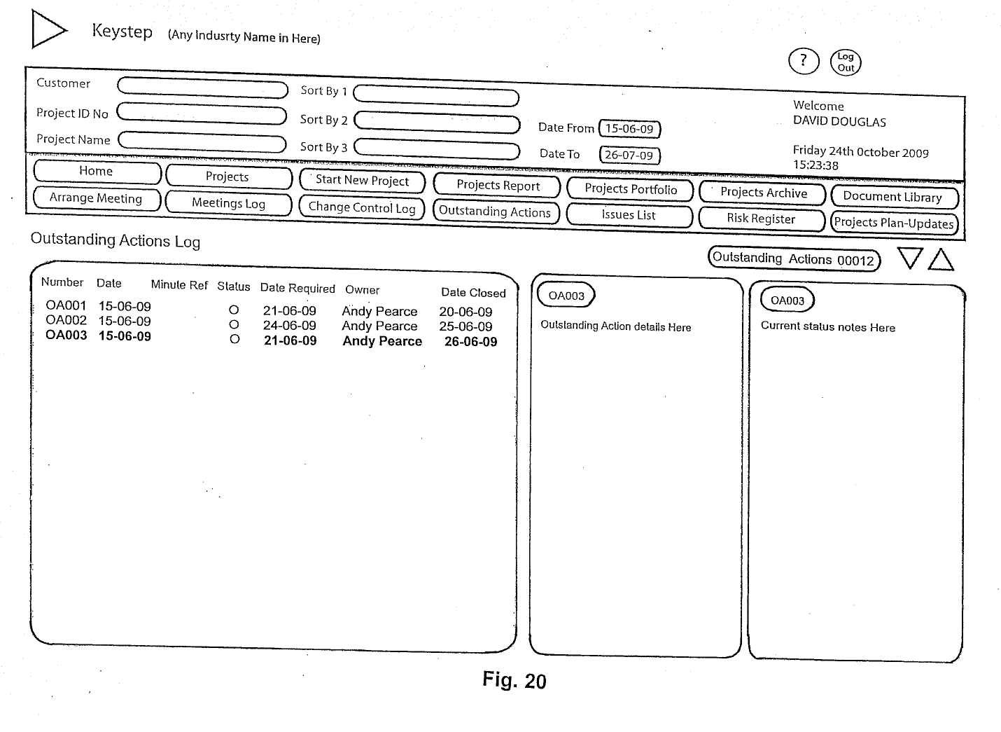

The system enables users at the user interface to implement Project Portfolio Management, illustrated in FIG. 4; various phases of Project Management, as illustrated in FIG. 7; Document Management, as illustrated in FIG. 11; Quality Gate Management, as illustrated in FIG. 18; Project Progress and related reports, illustrated in FIG. 20; and Project Planning, as illustrated in FIG. 32.

The data access layer is responsible for retrieving and manipulating data received from one of both of the user interface and the database. The data access layer also provides information to the user interface for display to a user. The user interface can be used to perform document management, monitor workflow instructions, modular business processes, quality gate clearance, project governance, health of the end-to-end project process phases, team contacts, project reports, monitoring the project portfolio health and a projects archive. The user interface may be a web portal or any other suitable means to access the database.

For the purposes of the present application a project includes seven phases; sales order entry, project planning, design, customer approval, build and configuration, customer handover and project closure (including a post-project review). The skilled person will understand that the number and type of phases can be varied for each particular project.

Each phase is provided with at least one quality control gate. Preferably, each phase is provided with two quality control indicators. The first indicator shows the current status of the work in progress towards completion of the QG and the second indicates when the Quality Gate has been completed and the work in progress passed to the next process phase.

On the Projects Portfolio View, the colour status indicators remain white until the work in progress on a project enters the process phase. When the project reaches a specific process phase, the indicator will change in colour to green (process on time), amber (process is suffering delay), or red (planned date exceeded/threat to the project completion). Examples of a threat to the project completion could be the forecasting of a budget overspend that is beyond the tolerances allowed by current company policy, or a time delay causing the forecast project completion date to exceed an external date constraint that is fixed.

Within the system, two or more individual projects may be combined to form a ‘programme’. Multiple programmes can exist for a user. The term ‘portfolio’ refers to all individual projects and/or programmes for a user.

Presentation of the System

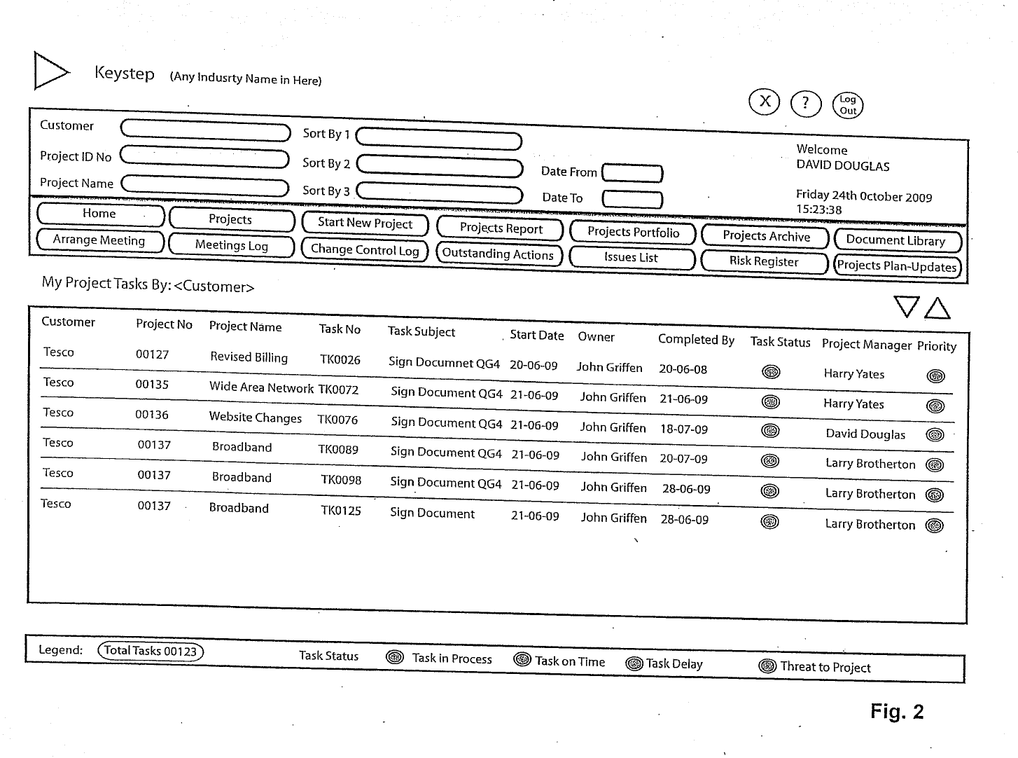

The screen-based views within the system are all based on a consistent design template (illustrated in FIG. 2) that ′ comprises of (from the top) a screen header section, a data header section, a system menu, a data descriptor, an area reserved for the data content for the selected view and a legend bar.

The screen header section (optionally) displays a graphics file from the database (e.g. company logo or text string) in the top left-hand corner and tool buttons in the top right-hand corner, commencing with the mandatory Log Out and Help buttons. Other (optional) buttons may be displayed, including the Tools button, if the logged-in user is a system or subscriber organisation administrator.

Below the screen header section is the data header section, with multi-purpose fields for 1) displaying details for the currently selected record and 2) inputting query criteria for a search), for example: the customer, project ID and project name fields. The data header section also contains Sort By fields, used to order the information displayed (for example, sort by alpha order or earliest start date), date to and date from fields to specify data range constraints for returning search results and the name of the user that has logged into the system and the current date and time.

Below the data header section is the system menu, consisting of multiple rows of buttons used to navigate between project and project portfolio functions. For example, FIG. 2 shows the following portfolio links in the upper row: Home; Projects; Start New Project; Projects Report; Projects Portfolio; Projects Archive and Document Library and the following project level actions and reports in the lower row: Arrange Meeting, Meetings Log, Change Control Log, Outstanding Actions, Issues List, Risk Register and the Project Plan & Updates.

Below the menu system is a section containing the data descriptor on the left-hand side (for example, My Project Tasks) and, where appropriate, scroll controls used to navigate the data list within the view.

Within the design template, the area reserved for the data content for the selected view is blank.

At the bottom of the screen is the legend bar containing, for example, a key to the symbol colours used within the screen view, a count of the number of items if the screen contains a list and controls to invoke contact with team members via Instant Messaging (IM).

The above screen header, data header, menu system and data descriptor are presented on all system views, for a consistent user experience. The legend bar is also displayed within most views, but the skilled person will understand that the contents of the legend bar will vary in relation to the contents of the screen, or that it may be optional if its presentation is not appropriate to the screen contents.

Use of the System

Access to the system is gained through the input and verification of a user ID and associated password, maintained by the subscriber lead contact in the role of administrator. Each user ID has an associated system role, for example, Project Manager, which is used by the security software, in conjunction with project personnel allocations for the individual user ID and any user-specified search criteria, to determine the detail of the content that is subsequently displayed.

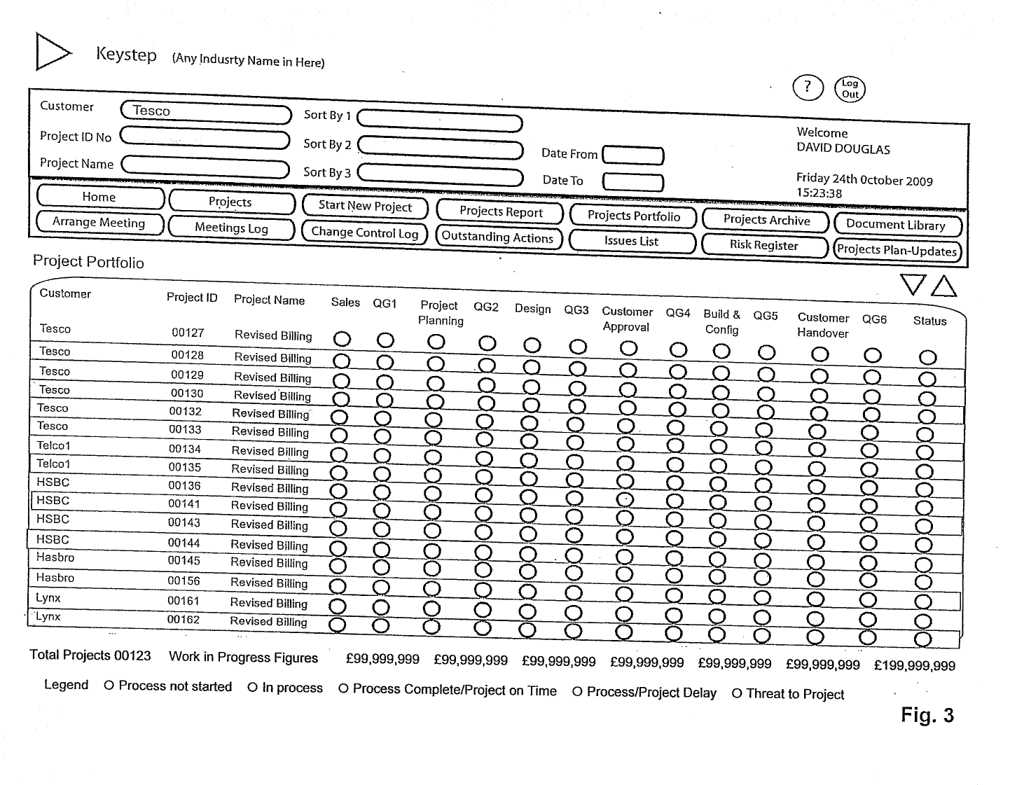

Upon logging into the system, the first screen presented is the user project tasks view, as illustrated in FIG. 3, consisting of a list of Project Tasks to be completed by the logged in user, with their associated status and priority. The data display includes the appropriate hyperlinks for the user to click to view details and record progress or completion of a task. The progress and completion of tasks recorded within the database is reflected in the colour status indicators for both individual tasks, their associated Quality Gates and the overall project. The completion of a task will remove it from the list.

The items for inclusion within a user project tasks view are originated from various sources, for example, the project schedule, the outstanding actions list, the change control, risk and issue logs and meeting minute actions. The item must be allocated to the user for completion.

The data access layer is arranged to feed summary project tracking information into the Project portfolio view, which can be displayed on the user interface, as illustrated in FIG. 4. The Project portfolio view has display columns for, at least, the customer name, project number, project name, the project process phases and their associated Quality Gates (QG); for example Sales Order Entry and QG1, Planning and QG2, Design and QG3, Customer Approval and QG4, Build & Configuration and QG5, Customer Handover and QG6, the overall Project Status and Project Closure.

Multiple projects can be listed, by customer, with a project number and name and two colour indicators for each process phase of the project life-cycle. The first indicator shows the current health of the work in progress towards completion of the QG and the second indicates when the Quality Gate has been completed and the work in progress passed to the next process phase.

Preferably, colour indicators are used to indicate the status of each phase of the project. The colour indicators may remain white until the work in progress on a project enters the process phase. When the project reaches a specific process phase, the indicator will change in colour to green (process on time), amber (process is suffering delay), or red (planned date exceeded/threat to the project completion).

Time delays can be measured by the system, through comparison with baseline information regarding the planned completion of low level tasks and documents within each Quality Gate, input as part of the Project Plan.

The Quality Gate indicator can be one of three colours; white (the project has not entered the process phase), blue (the project is currently in the process phase), or green (the Project has passed through the Quality Gate into a subsequent process phase).

Under the final column in the display (Project Status), the colour indicator indicates the overall health of a project, and will vary in colour from green (project on track), to amber (project delay), or red (threat to project).

Preferably, the data access layer automatically changes the colour of the project process colour indicators based upon information received from the user interface such as the reporting of task, document and Quality Gate completion. Preferably, when a user clicks on a colour indicator the data access layer causes the user interface to display further detail for a process phase of a particular project. This enables a user to review or investigate a list of issues that have arisen during that process phase of the project.

When a colour indicator under a quality gate is selected, the data access layer opens a page for that particular project phase quality gate, such that a user can review or approve a particular project phase quality gate.

The Project Portfolio may also be viewed by a user for insight into trends and overall performance of a portfolio (or programme). The Project Portfolio view has scroll up and down arrows for viewing all projects within the portfolio and, within the legend bar, a counter for the total number of customer projects. A user may limit the Project Portfolio View Project portfolio view to display projects associated with, for example, a single customer organisation by using the customer search criteria input field in the data header section.

The level of information present in the Project portfolio view will also vary according to the security profile of the logged-in user.

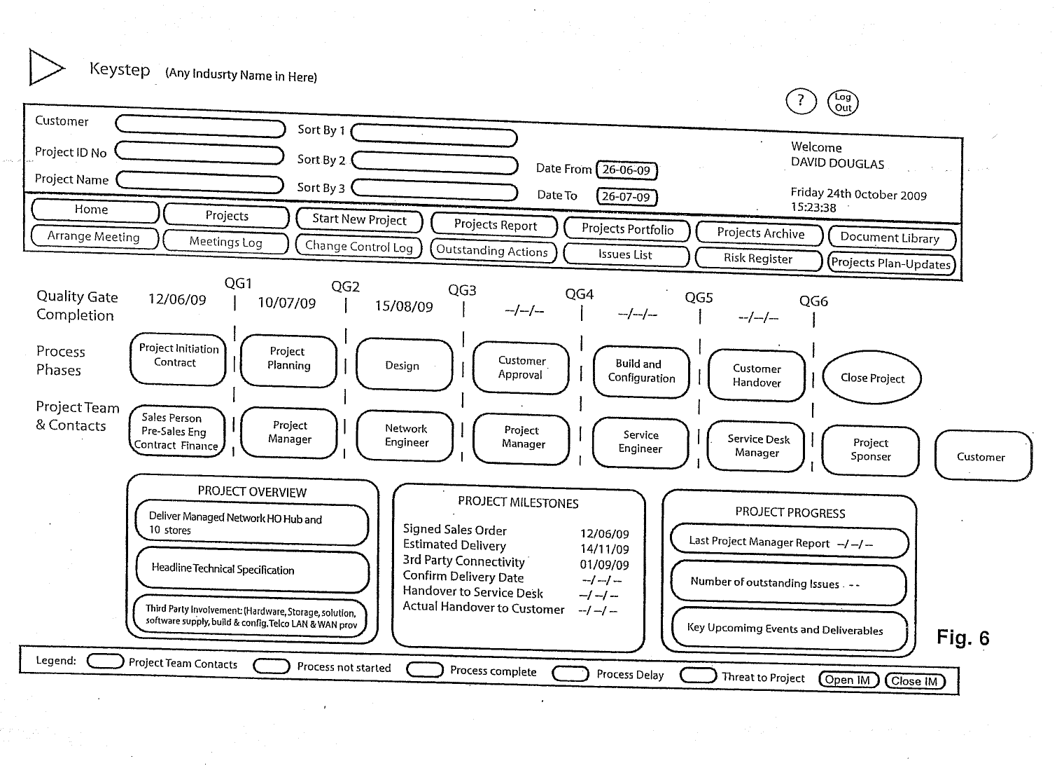

A project is normally transferred into the projects archive when it has passed through each project phase, each quality gate and the post-project review has been conducted by the project manager. Following completion of the post project review, the project is formally closed by the issue of the Project Closure report and the project will be transferred to the archive automatically (illustrated in FIG. 6).

An exception to this is a cancelled project. A project cancelled mid-project cycle can be transferred into the projects archive by a user logged into the system as a Project Manager. Preferably, the project can only be cancelled when the data access layer receives a completed and signed project cancellation process form in the close project process phase from a user logged in as customer for the project.

The project archive enables a user to access projects stored on the database that have been completed or cancelled. It provides a reference for previous project information and lessons learnt. Preferably, the data access layer causes the user interface to display the project archive in the same way as the project portfolio view

As well as enabling direct access to lower level processes and issue reviews, the Project Portfolio view can list all projects sorted by a number of criteria; for example, Alphabet, Budget, Category, Customer, Delivery Date, Importance, Interdependencies, Level of Risk, Product, Profitability, Project Manager, Region and Current Date. This flexibility of viewing the Project portfolio view through its structure and coloured indicators, allows users valuable insight into strategic and tactical patterns and trends emerging within the business. For example, listing the Project Portfolio by Current date will indicate how each department of the business involved in project delivery is performing. If the coloured indicators for a particular department are more weighted to Amber and Red, that area of the business is under performing and requires closer scrutiny (the department could be under resource, too remote from the project team, have high absenteeism, etc).

Starting a New Project

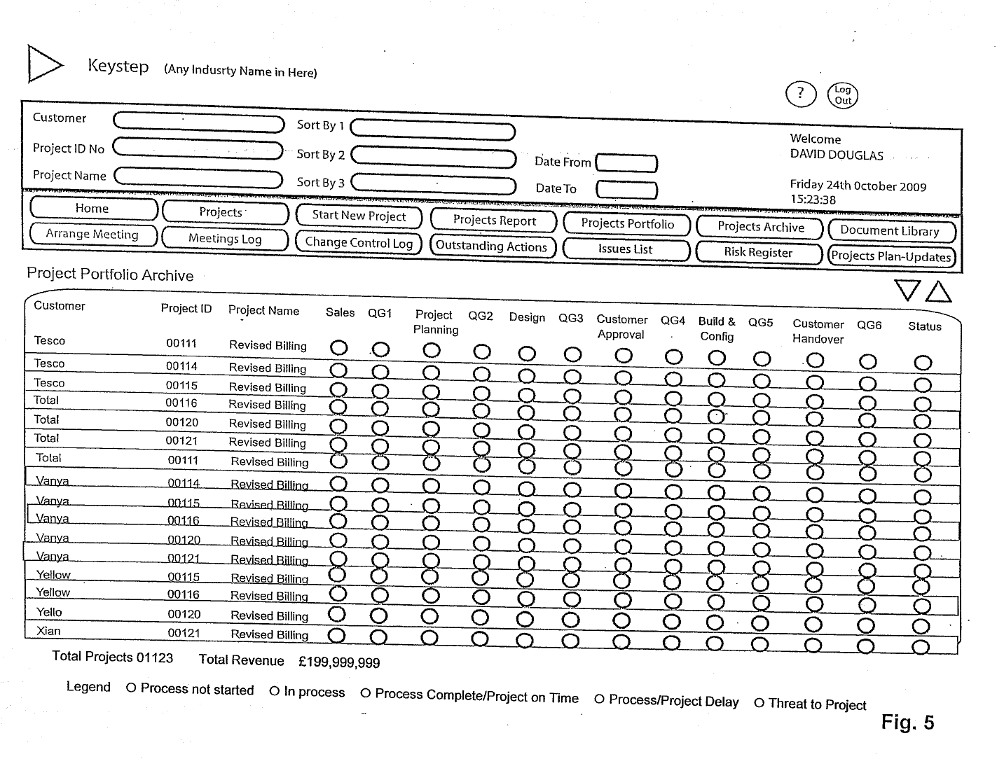

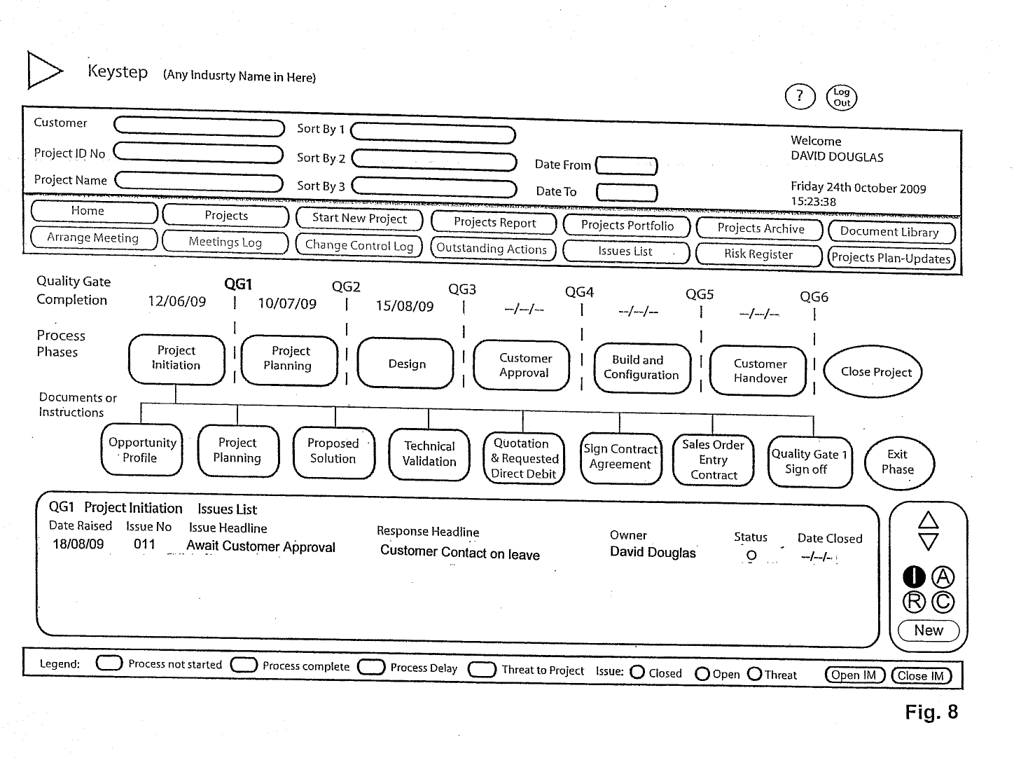

FIG. 7 illustrates a possible display on a customer user interface when a user selects to initiate a new project. The Start New Project screen, shown in FIG. 7, populates a new project's home page, such as the project internal project phase view, illustrated in FIG. 8. In response to a user entering the customer name into the customer name field, the system causes a project number to be assigned to the project. Optionally, the project number may be confirmed by the user, for example by clicking the Projects Home link in the system menu. A project may be also marked as a multi-site project (as illustrated in FIG. 5), which will:
Facilitate the definition of the number of multiple project lines, and their associated descriptions, to be created utilising the same template (one per site allowed)
Amend the project portfolio view for multi-site projects to include the project ID and name within the data descriptor line, so that the space normally reserved for these items can be used to display the additional site descriptions (see above).

The system now opens the Project Home page illustrated in FIG. 8 and causes it to be displayed on the user display, with full functionality. Preferably, if the User opens Start New Project page and does not enter a customer name prior to opening the Project Home Page no actions are performed by the system when a user selects any of the icons.

The Project Home Page (FIG. 8) contains process phase icons for an end to end view of the project life-cycle. Clicking on any process icon will open the lower level process. Each process phase can be given its own completion date and each process phase has its own Quality Gate. Clicking on any of the six Quality Gates will open the appropriate Quality Gate document, for review or editing.

Monitoring Progress of a Project

Once each process phase in a project enters its process cycle, dependant on the timeliness of its lower processes, the process phase icon will change colour to green (process on time), amber (process delay), or red (threat to project). Once an end to end process phase icon changes from green, amber or red, that process phase icon remains at amber or red, even if the issue has been resolved and the process phase has completed its process cycle and cleared the quality gate. In doing this, each project has a snapshot which can easily be traced for further information and lessons learnt.

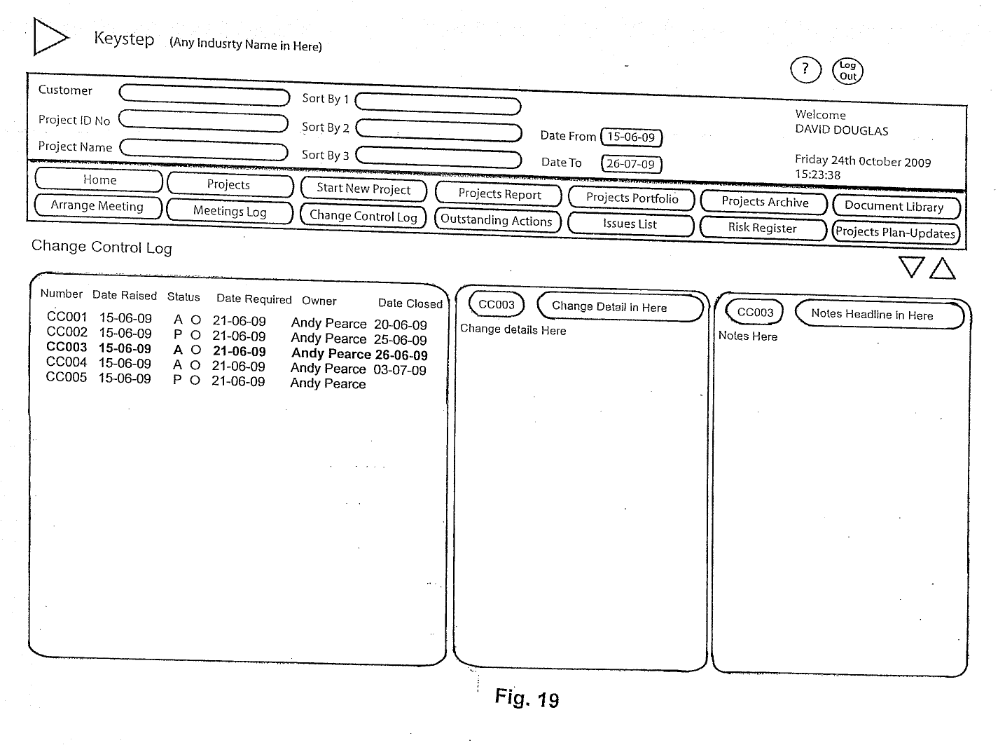

Preferably, associated with the end to end process phase icons are project team contact icons. Selecting a project team contact icon below a process phase may open up the contact details and an image of the team member responsible for that process phase as illustrated in FIG. 19. The user may be able to see other members of the project team by scrolling the contact details for the team up or down. Optionally, the contact details may include the option to call or email the team member. The Project Team contact icons can include roles that are not assigned tasks, but whom may be contacted in connection with the progression of the project. For example, a company director owning the departmental budget that is funding the project (i.e. the project sponsor may be required to make a decision to help resolve an issue.

Beneath the Project team contact icons are three information windows containing hi-level details of the project. The three windows are: project overview, milestones and project manager readout. The project overview contains a brief high level description of the project objective, technical specification and required third party involvement. The milestones window contains the projects key milestone dates. The project manager readout window contains a date for the Project Manager's latest report, key issues and upcoming events.

Advantageously, at the bottom of the project home page window is a legend colour guide to the status of a project process phase: white; project team contact; blue, process not started; green, Process complete; yellow, Process delayed by 1 week or more and red, threat to project. Once a project is active the Home Page, illustrated in FIG. 8, has an internal view for users responsible for delivering the project (external customers have their own project home page view).

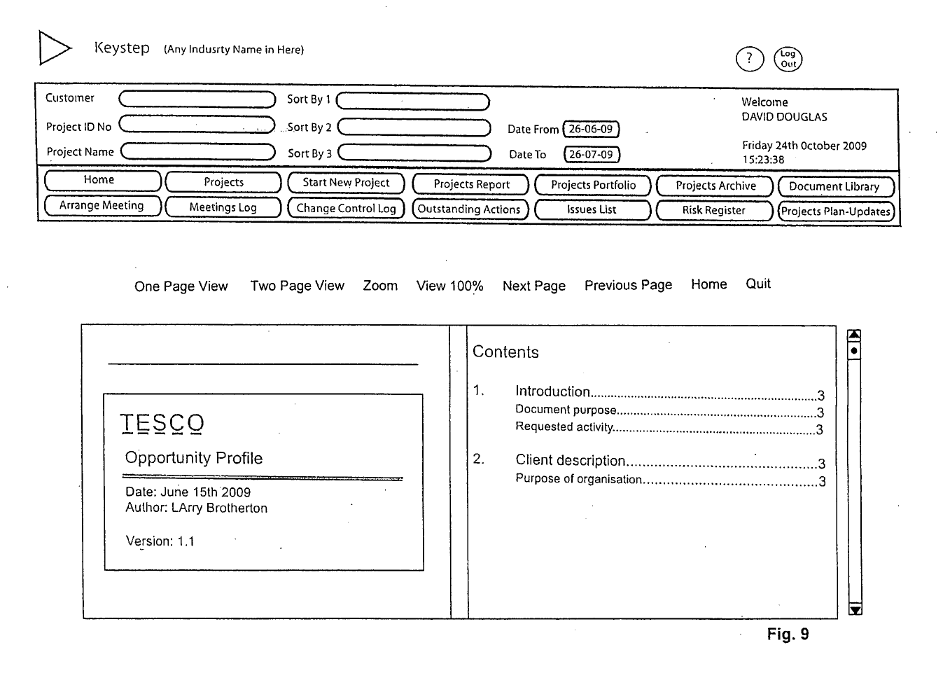

The projects home page illustrated in FIG. 9 is for viewing by external customers, for whom the project is being provided. The customer's view of the project home page offers the same functionality as the internal view of the project home page as described above, but with the following differences: the customer's middle title bar offers a project home page link, customer projects link, customers archive and the help link. Another difference is that the customer project home page offers selected project team contact details. For example, these may be limited to: the account manager, project manager, project sponsor and the customer's contact details. Finally, the Customer may be prevented from accessing any price sensitive information.

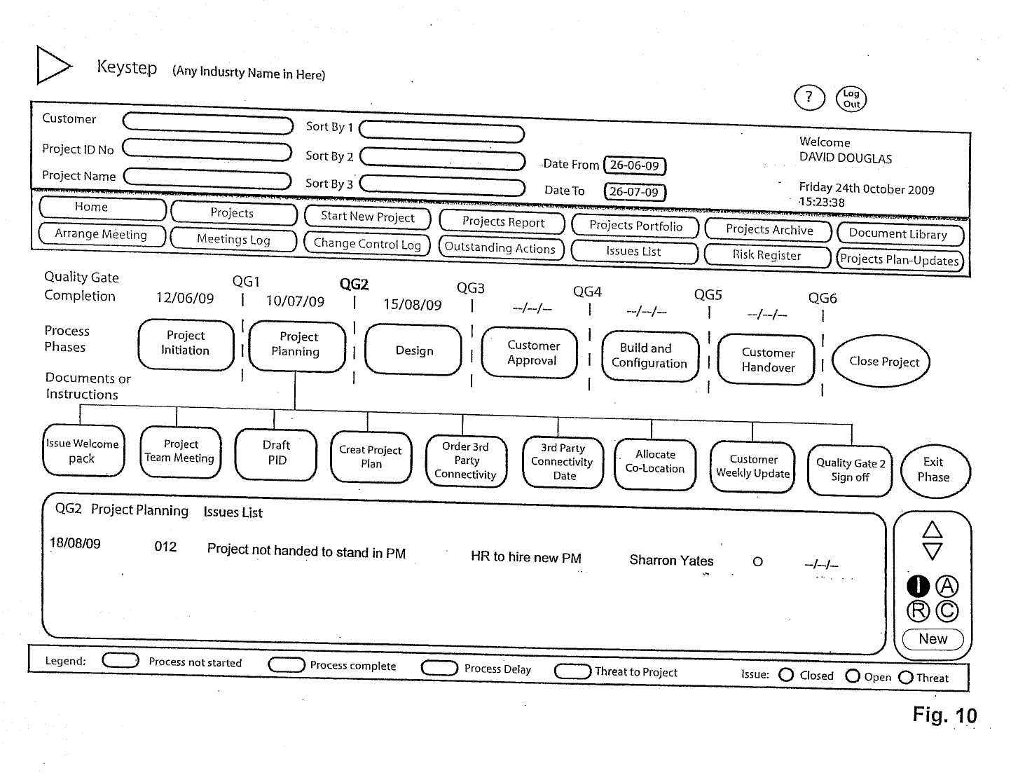

Once a project is activated by opening the Project Home Page illustrated in FIG. 8, the user can access lower level process illustrated in FIG. 10 or a document, illustrated in FIG. 11. For example, in order to review or edit a document in the sales order entry process phase, the user selects the sales order entry icon which opens up a new view of the internal project phase view, illustrated in FIG. 10. This causes the user interface to display the end to end process phases and their quality gates, a row of lower level processes and document icons related to the sales order entry phase. These icons link to documents or process instructions to complete the sales order entry process phase.

Preferably, all documents and process instructions have milestone date fields allowing documents and processes to be measured against the expected process phase completion date at the quality gate.

A lower level process or document running beyond a pre-set quality gate milestone will change said lower process icon from green to amber. If the lower process delay is beyond a second pre-set date, or is deemed an issue that is a threat to the overall project, the Icon will change from Amber to Red.

Any of the lower process icons changing from green to amber or red will, in this example, change the upper process phase sales order entry icon to amber or red where the icon colour will remain, even after the process phase has been completed and has passed through the Quality Gate. The purpose of this is to maintain a contemporary history of project progress and departmental performance that can be accessed subsequently with the minimum of effort.

Quality Gates

As indicated previously, the quality gates within any project can be accessed by selecting, at the user interface, the colour indicator of said project quality gate in the project portfolio view, as illustrated in FIG. 4. Alternatively, the quality gate may be accessed by selecting, at the user interface, the project quality gate number above its process phase in the internal project phase view, illustrated in FIG. 8 or any of the lower process phase levels, such as sales order entry, illustrated in FIG. 10.

Selecting a project quality gate will open a new project home page at the requested process phase quality gate with just that quality gate in view, to be updated, edited or reviewed. Once this is done, a user can scroll up or down to view the other quality gates associated with the project. Alternatively, the user may close the window and return to the previous project home page or the project portfolio view.

Each process phases' quality gate has a number of document and process fields related to the process phase along with start and completion dates provided by and accepted by the different project process phase owners (more than one person may own documentation or process completion for a phase).

Sample Project Phases

Sales Order Entry Phase

To access a document or a process instruction document residing in the lower processes of the sales order entry process the user selects the lower process icon in question resulting in the data access layer displaying the document, as illustrated in FIG. 11, on the user interface. The user can then edit or review the document, for example, by scrolling the document pages up or down.

If the document selected is not a process instruction, and the production of the document is yet to be commenced, the system automatically selects ‘create document’ mode (as illustrated in FIG. 44) and presents the user with the option of creating the document using the generic document template for the project, or selecting an existing document from the document library (as illustrated in FIG. 45), to utilise as a template. Otherwise the existing document is selected for edit.

Optionally, documents may have flexibility on how much information needs to be entered before a document is regarded as completed. It is preferable that each document has an owner responsible for the document, start and closing date fields, records any amendments to the document within the document history, and automatically increments the document version. Once the user has reviewed, edited, or completed process instructions in a document of the lower process of the sales order entry phase, the user saves the document, exits the saved document, and then returns to the internal project phase view, illustrated in FIG. 8.

Similarly, the above document management process is invoked from project phase, when project issues, risks, actions or change requests are being managed.

The sales order entry page also displays, in the lower data panel as illustrated in FIG. 10, any current issues, risks, actions or change requests related to the sales order entry process phase, including a status summary. The choice of display is selected from the navigation panel, located to the right of the details display. The drill down facility may be used to view the full details of the item. Preferably, each issue has its own colour indicator to indicate if it is closed (green), open (amber) or open and a threat to the project (red). The Issue Headlines are extracted from the Issues List. Optionally, the issues list can be scrolled up or down, using the scroll buttons within the navigation panel. Also optionally, a new item appropriate to the display mode selected at the time may be raised via the ‘new’ button, also located within the navigation panel. Within this view, a user may also open the instant messaging facility, using the Open IM button located at the right-hand side of the Legend bar at the bottom of the screen. Similarly, when open, the instant messaging facility can be closed, using the adjacent Close IM button.

Project Planning Phase

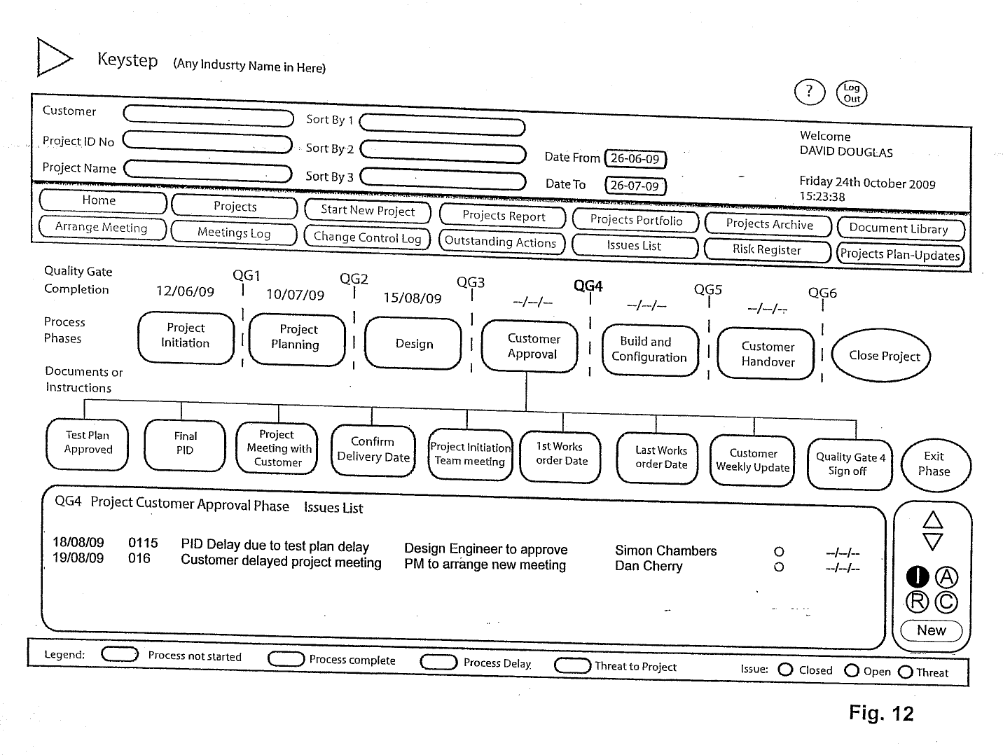

Once the sales order entry phase and quality gate 1 are completed, the user may wish to access the next project process phase, for example, project planning, to review or edit documents in the project planning process phase. The user returns to the internal project phase view and selects the project planning icon, displayed on the user interface (illustrated in FIG. 8), which opens a detailed view of the selected project phase, as illustrated in FIG. 12. The user interface displays the end-to-end process phases and their quality gates, plus a row of lower level processes and document icons related to the project planning process phase.

The lower level icons are links to documents or process instructions (example FIG. 11), to complete the project planning process phase.

As in the sales order entry phase, all documents and process instructions have milestone date fields allowing documents and processes to be measured against the expected process phase completion date at quality gate 2.

A list of issues is displayed on the project planning process page and whether that issue is open or closed. Preferably, each issue has its own colour indicator to indicate if it is closed (green), open (amber) or open and a threat to the project (red). The Issues Headlines are extracted from the Issues List. Preferably, selection of any issue opens access to more detail of said issues. Optionally, the issues list can be scrollable up or down.

To access a document or a process instruction document residing in the lower processes of the project planning phase the user selects the lower process icon in question resulting in the data access layer displaying the document, as illustrated in FIG. 11, on the user interface. The use can then edit or review the document, for example, by scrolling the document pages up or down.

Design Phase

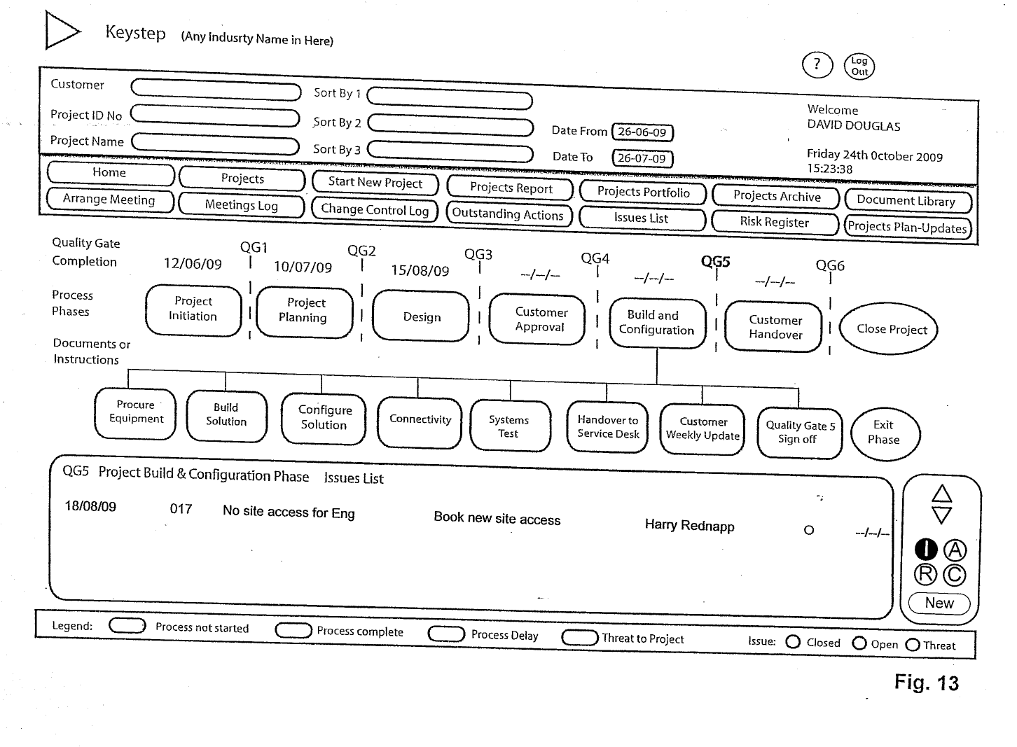

Once the project planning phase and quality gate 2 are completed, the user may wish to access the next project process phase, project design as illustrated in FIG. 8, to review or edit documents in the project design process phase. The user selects the project design icon, displayed on the user interface, which opens a detailed view of the project phase, as illustrated in FIG. 13. The user interface displays the end-to-end process phases and their quality gates, plus a row of lower level processes and document icons related to the project design phase.

These Icons are links to documents or process instructions (example FIG. 11), to complete the project design process phase.

As in the sales order entry phase, all documents and process instructions have milestone date fields allowing documents and processes to be measured against the expected process phase completion date at quality gate 3.

A list of issues is displayed on the project planning process page and whether that issue is open or closed. Preferably, each issue has its own colour indicator to indicate if it is closed (green), open (amber) or open and a threat to the project (red). The issues are headlines fields taken from the Issues List. Preferably, selection of any issue opens access to more detail of said issues. Optionally, the issues list can be scrollable up or down.

To access a document or a process instruction document residing in the lower processes of the project design phase the user selects the lower process icon in question resulting in the data access layer displaying the document, as illustrated in FIG. 11, on the user interface. The use can then edit or review the document, for example, by scrolling the document pages up or down.

Customer Approval Phase

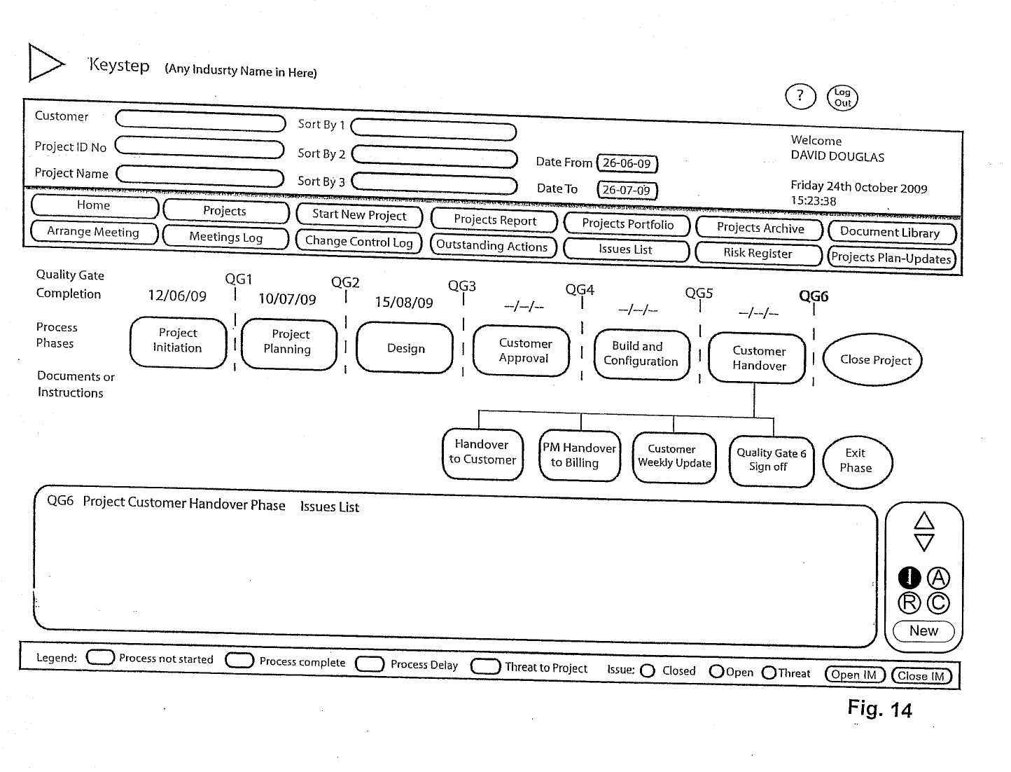

Once the project design phase and quality gate 3 are completed, the user may wish to access the next project process phase, customer approval as illustrated in FIG. 8, to review or edit documents in the customer approval phase. The user selects the customer approval icon, displayed on the user interface, which opens a detailed view of the project phase, as illustrated in FIG. 14. The user interface displays the end-to-end process phases and their quality gates, plus a row of lower level processes and document icons related to the project design phase.

These icons are links to documents or process instructions (example FIG. 11), to complete the customer approval phase.

As in the sales order entry phase, all documents and process instructions have milestone date fields allowing documents and processes to be measured against the expected process phase completion date at quality gate 4.

A list of issues is displayed on the customer approval page and whether that issue is open or closed. Preferably, each issue has its own colour indicator to indicate if it is closed (green), open (amber) or open and a threat to the project (red). The issues are headlines fields taken from the Issues List. Preferably, selection of any issue opens access to more detail of said issues. Optionally, the issues list can be scrollable up or down.

To access a document or a process instruction document residing in the lower processes of the customer approval process the user selects the lower process icon in question resulting in the data access layer displaying the document, as illustrated in FIG. 11, on the user interface. The use can then edit or review the document, for example, by scrolling the document pages up or down.

Build & Configuration Phase

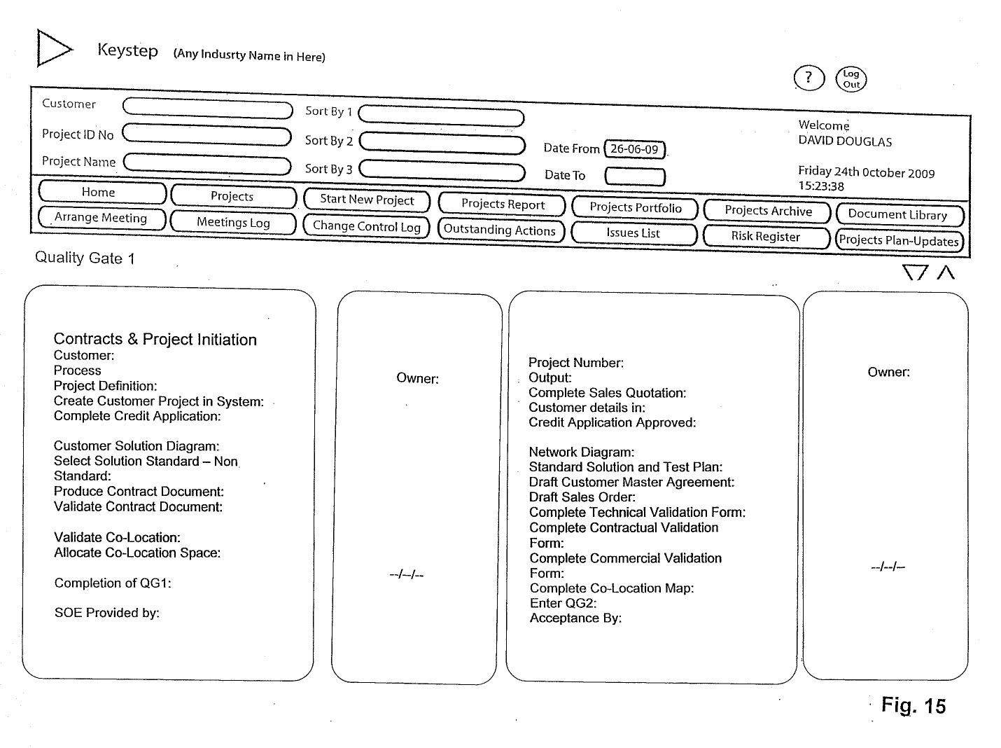

Once the customer approval phase and quality gate 4 are completed, the user may wish to access the next project process phase, build and configuration as illustrated in FIG. 8, to review or edit documents in the build and configuration phase. The user selects the build and configuration icon, displayed on the user interface, which opens a detailed view of the project phase, as illustrated in FIG. 15. The user interface displays the end-to-end process phases and their quality gates, plus a row of lower level processes and document icons related to the project design phase.

These icons are links to documents or process instructions (example FIG. 11), to complete the build and configuration phase.

As in the sales order entry phase, all documents and process instructions have milestone date fields allowing documents and processes to be measured against the expected process phase completion date at quality gate 5.

A list of issues is displayed on the build and configuration page and whether that issue is open or closed. Preferably, each issue has its own colour indicator to indicate if it is closed (green), open (amber) or open and a threat to the project (red). The issues are headlines fields taken from the Issues List. Preferably, selection of any issue opens access to more detail of said issues. Optionally, the issues list can be scrollable up or down.

To access a document or a process instruction document residing in the lower processes of the build and configuration phase the user selects the lower process icon in question resulting in the data access layer displaying the document, as illustrated in FIG. 11, on the user interface. The use can then edit or review the document, for example, by scrolling the document pages up or down.

Customer Handover Phase

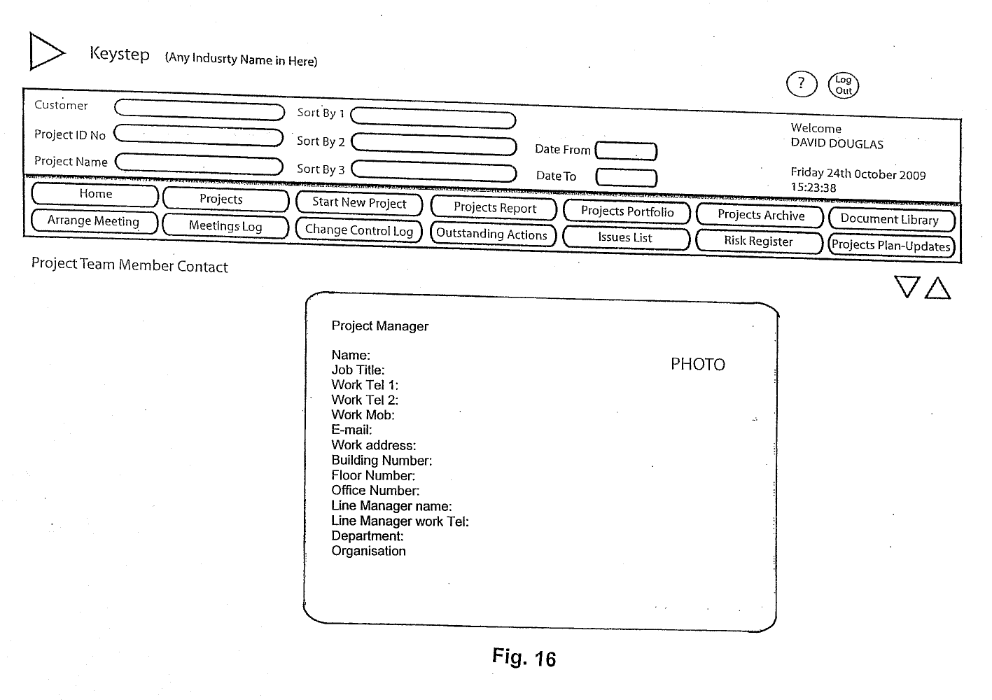

Once the build & configuration phase and quality gate 5 are completed, the user may wish to access the next project process phase, customer handover as illustrated in FIG. 8, to review or edit documents in the customer handover phase. The user selects the customer handover icon, displayed on the user interface, which opens a detailed view of the project phase, as illustrated in FIG. 16. The user interface displays the end-to-end process phases and their quality gates, plus a row of lower level processes and document icons related to the project design phase.

These icons are links to documents or process instructions (example FIG. 11), to complete the customer handover phase.

As in the sales order entry phase, all documents and process instructions have milestone date fields allowing documents and processes to be measured against the expected process phase completion date at quality gate 6.

A list of issues is displayed on the customer handover page and whether that issue is open or closed. Preferably, each issue has its own colour indicator to indicate if it is closed (green), open (amber) or open and a threat to the project (red). The issues are headlines fields taken from the Issues List. Preferably, selection of any issue opens access to more detail of said issues. Optionally, the issues list can be scrollable up or down.

To access a document or a process instruction document residing in the lower processes of the customer handover phase the user selects the lower process icon in question resulting in the data access layer displaying the document, as illustrated in FIG. 11, on the user interface. The use can then edit or review the document, for example, by scrolling the document pages up or down.

Close Project Phase

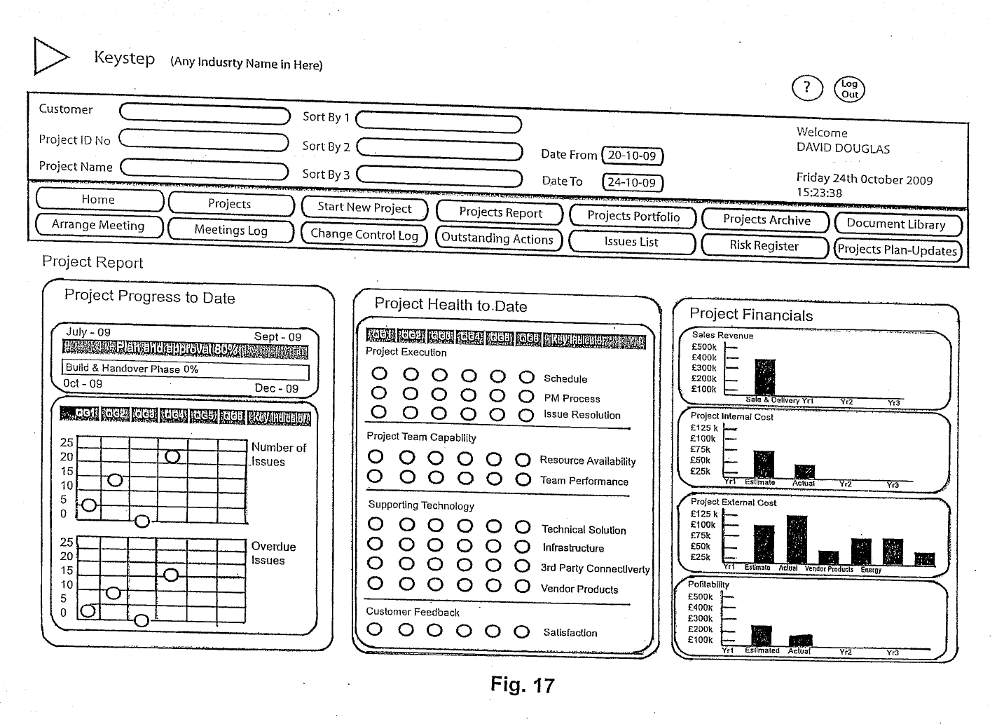

Once the customer handover phase and quality gate 6 are completed, the user may wish to access the next project process phase, close project as illustrated in FIG. 8, to review or edit documents in the close project phase. The user selects the close project icon, displayed on the user interface, which opens a detailed view of the project phase, as illustrated in FIG. 17. The user interface displays the end-to-end process phases and their quality gates, plus a row of lower level processes and document icons related to the project design phase.

These icons are links to documents or process instructions (example FIG. 11), to complete the close project phase.

As in the sales order entry phase, all documents and process instructions have milestone date fields allowing documents and processes to be measured against the expected process phase completion date on transfer to the projects archive.

A list of issues is displayed on the close project page and whether that issue is open or closed. Preferably, each issue has its own colour indicator to indicate if it is closed (green), open (amber) or open and a threat to the project (red). The issues are headlines fields taken from the Issues List. Preferably, selection of any issue opens access to more detail of said issues. Optionally, the issues list can be scrollable up or down.

To access a document or a process instruction document residing in the lower processes of the close project phase the user selects the lower process icon in question resulting in the data access layer displaying the document, as illustrated in FIG. 11, on the user interface. The use can then edit or review the document, for example, by scrolling the document pages up or down.

Project Reports

To view high level collective Project details, the Project Manager and other users of the system may select the project reports view link. The link may be found, for example, in the system menu (see FIG. 2). Opening the project report view (FIG. 20) presents the user with a new view, consisting of three information panels with further visual data related to the health of the project.

The first window illustrates the project progress to date, including, for example, a simple dated bar chart of the projects progress and phases to date. Optionally, the first window includes one of ten interchangeable project key indicator charts (for example, the number of issues raised during each phase and the number of issues raised for a phase that were still outstanding when all scheduled tasks had been completed), related to the key project health indicators as deemed by the customer and project sponsor.

In another window the key indicators are measured by the numbered quality gates and the red, amber and green colour indicators. Advantageously, the key indicators may be changed dependent on the Customer and the project.

In a further window high level financial information bar charts are displayed. These charts include, for example, project sales revenue, opportunity cost, external spend and profitability. At the bottom of the project report page is a legend with a key to the information reported in each window.

Meeting detail and reports can be accessed by selecting a link on a title bar of the project report page. These links include, for example, meetings archive, change control log, outstanding actions, issues list, risk register and the project manager's project plan & updates. These are discussed in more detail below.

Meetings Log

The Meetings Log screen, illustrated on a user interface in FIG. 29 is preferably made up of four windows. On the left, in the first window, are fields for logging meeting details related to the project. The fields may include: Meeting Number, Meeting Date, Meeting Requested by and Meeting Agenda. Below the window is a larger window with the Meetings Archive list. The right hand window contains the reviewed document fields including, for example, Meeting Number, Meeting Date, Meeting Requested by and Meeting Agenda. To open a new Meeting Document, there is a New Meeting and a document save link. The document to be reviewed, or edited, is populated in the larger window below the meeting fields.

Arrange Meeting

A Meeting is a specific form of Contact that can be set to repeat at a pre-defined frequency, using the Arrange Meeting view (illustrated in FIG. 30). The user will select the meeting date from a calendar and enter the Meeting Type (from a drop down), Meeting Location, Meeting Start Time, Meeting End Time and Meeting Title. The user will then select the Invited Personnel, who can be saved in a named Group Circulation List. The user is prompted to create the Meeting agenda, which can be made mandatory (depending on the setting of a system parameter for projects).

Set a Meeting Agenda

A Meeting Agenda is a specific form of Document that can be created using the Set a Meeting Agenda view (illustrated in FIG. 31). The details consist of a Meeting Title, Meeting Date, Meeting Start Time, Meeting End Time, Meeting Location, Invited Personnel, (these items can be brought forward from Arrange Meeting, see above) and Agenda Items. Once complete, the user confirms the creation of the Meeting and a) an Outstanding Action b) a Microsoft Outlook Calendar item are generated for all Invited Personnel. The acceptance of the Outstanding Action changes the status of the invited person to attendee.

Recording Meeting Minutes

A Meeting Minute is a specific form of Document that can be created using the Record Meeting Minutes view (illustrated in FIG. 32). The details consist of a reference to a Meeting record Unique ID [Meeting Title, Meeting Date and Time, Meeting Location, Agenda Items (all as per the Meeting Agenda)], Attendees and Recorded Minutes. A minute can be flagged to indicate that there is an associated Outstanding Action, in which case the Meeting Minute Unique ID is referenced on the Outstanding Action table.

Change Control Log

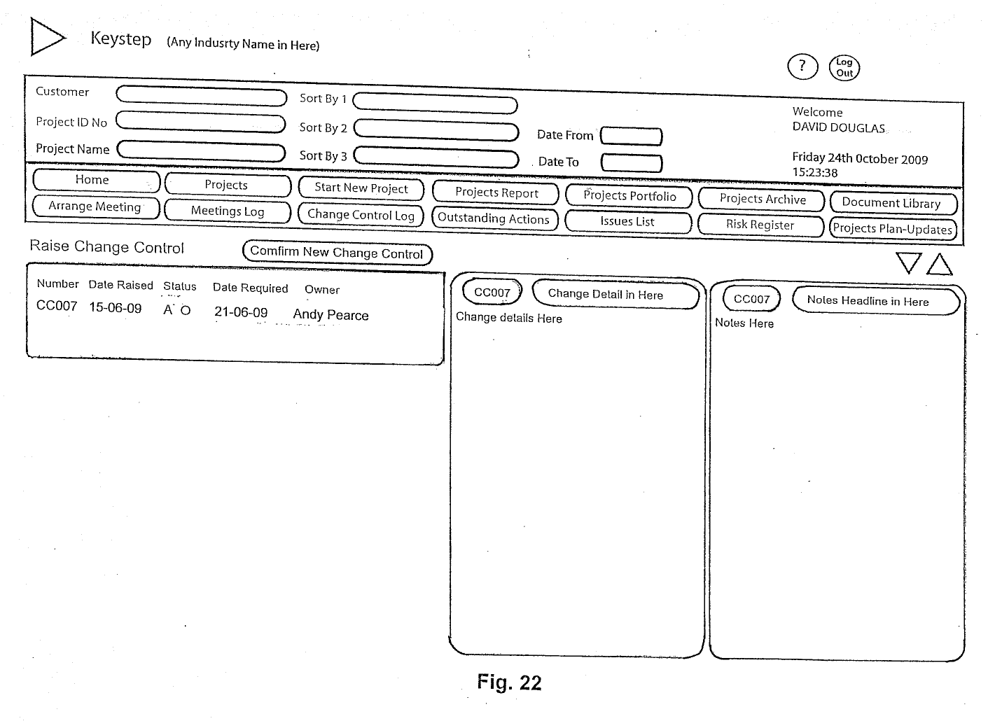

The Change Control Log link opens a new window, as illustrated in FIG. 22. The window displays the Change Control Log, preferably in tabular format. The purpose of raising an individual Change Control is to request an amendment to (any element of) the original definition of the project. For example, the scope may be amended to cover additional business process, the design inventory may be amended to provide a more powerful computer system or the budget may be increased to allow additional staff to work on the project. The important and differentiating feature of Change Control within this system is that it is necessary to indicate and record which existing project task(s) the requested change will an effect upon (this process has been named ‘pinning’). Due to the ‘pinning’ of changes to existing tasks, the system is capable of enforcing dependencies, by preventing the completion of a task or document (and therefore the associated project phase Quality Gate), if the related issue has not been completed. An individual change control can have a status of ‘Raised’, ‘Approved’ or ‘Complete’. A status of ‘Raised’ or ‘Approved’ will automatically prevent completion of a ‘pinned’ task or document, until a status of ‘Complete’ has been recorded.

The Change Control Log table contains columns for the following: Change Control reference number, the date the change was raised, the original target date for completing the change; the current change status; the change details, notes, the change owner and the actual date that the change was completed. The Change Control Log can be scrolled up or down using the scroll arrows.

A button, labelled ‘new’, is available to the user in order to create a new change request. In addition to recording the details listed above, the user defines which task or phase the change request is to be associated with. The association with a specific, time-limited task or phase (known within the invention as ‘pinning’), allows the system to maintain the correct display for the colour status indicators, of both the individual change request and the associated task or phase.

Raising a Change Control

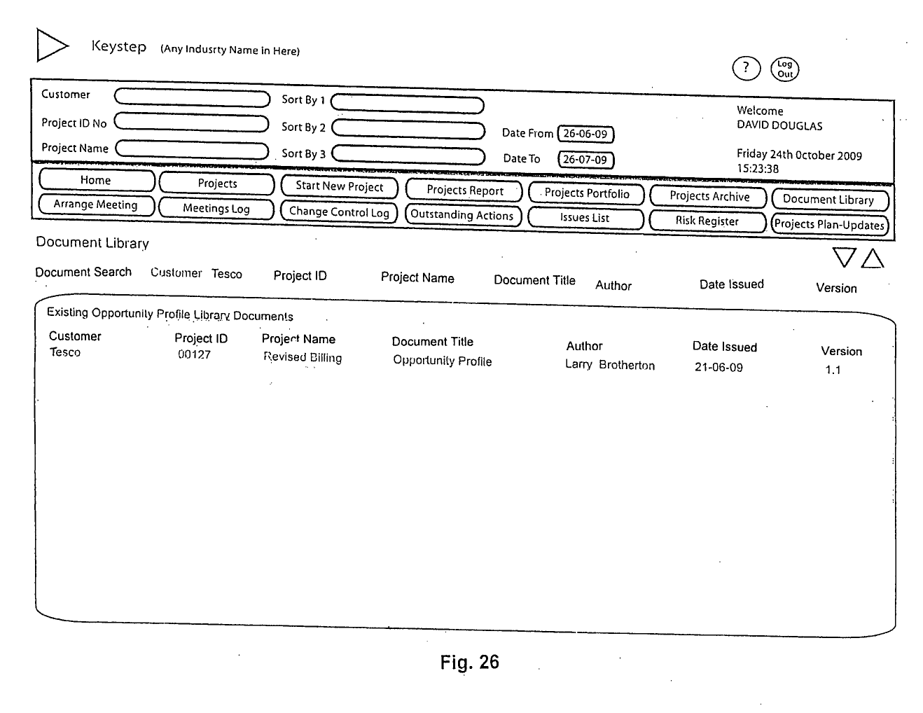

A Change Control request is raised by project personnel, using the view illustrated in FIG. 26, when they become aware of an item in the project configuration that requires amendment or change. If the Change is raised by a member of the team who does not have the security clearance to write directly to the Change Control Log, the item will be given a status of ‘Pending’ and an Outstanding Action created, linked to the Change Control, for the Project Manager to approve entry to the Change Control Log. Once the Change Control is accepted by the Project Manager, the status of the Change Control is changed to ‘Accepted’. Upon input, the change will be pinned to a specific project Phase, Task or Document. When the Quality Gate that includes the pinned Issue is reached, it should not be possible for the Project Manger to close the Quality Gate until the Change Control has been successfully resolved, when the RAG status should be changed to Green and the item closed.

Outstanding Actions

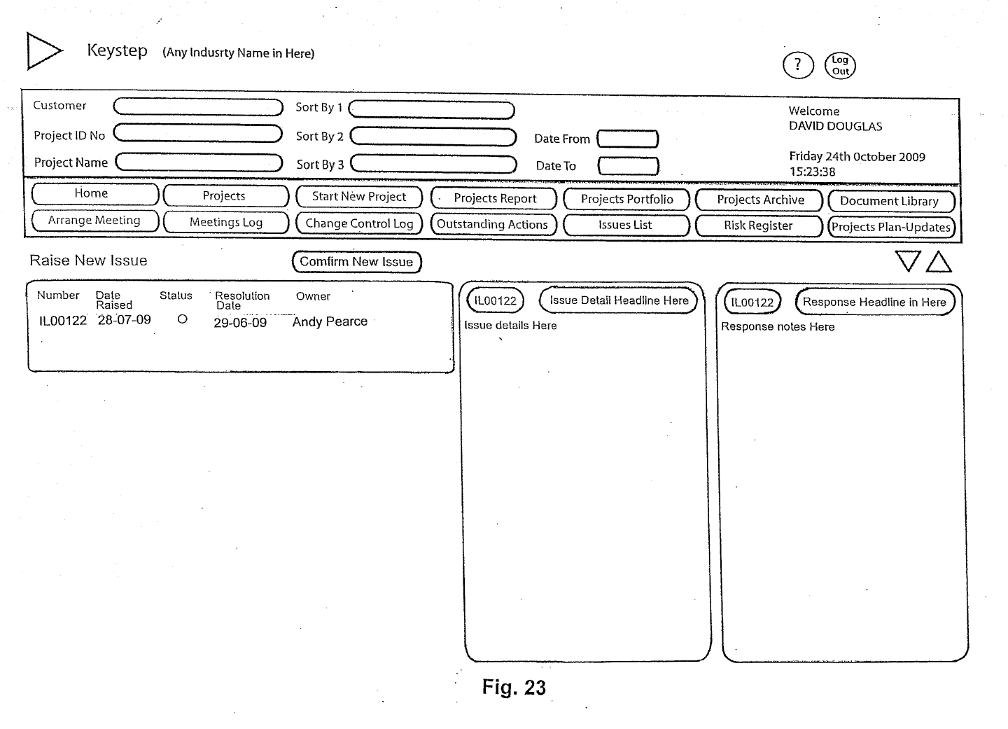

Selecting the Outstanding Actions List link on the user interface opens a new window, shown in FIG. 23. The window includes an outstanding actions list table that contains the following table columns; outstanding actions reference number, date, meeting minute reference number, status, date required, action, current status, owner and date closed. The user can click on the action and current status cells for more details. Preferably, the outstanding actions list can be scrolled up or down using the scroll arrows.

A button, labelled ‘new’, is available to the user in order to create a new action. In addition to recording the details listed above, the user defines which task or phase the action is to be associated with. The association with a specific, time-limited task or phase (known within the invention as ‘pinning’), allows the system to maintain the correct display for the colour status indicators, of both the individual action and the associated task or phase.

Raising an Outstanding Action

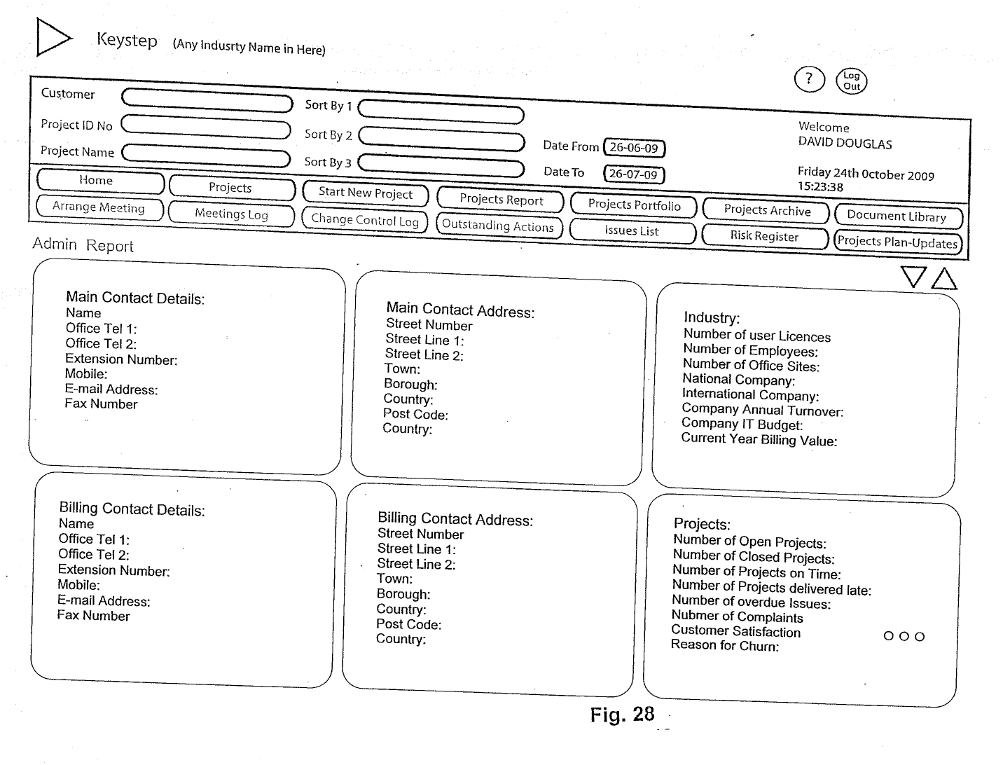

An Outstanding Action is raised by project personnel, using the view illustrated in FIG. 28, when they become aware of an item that the project needs to complete in order to progress. If the Action is raised by a member of the team who does not have the security clearance to write directly to the Outstanding Actions List, the Actions will be given a status of ‘Pending Acceptance’ and another Outstanding Action created, linked to the original Action, for the Project Manager to approve entry to the Outstanding Actions List. Once the Outstanding Action is approved by the Project Manager, the status of the Action is changed to Accepted. Actions will be pinned to a specific project Phase, Task or Document. Various system procedures (documented within this specification) will automatically create items within the Outstanding Actions List, for progression in the normal manner. When the Quality Gate that includes the pinned Action is reached, it should not be possible for the Project Manger to close the Quality Gate until the Action has been successfully completed, when the RAG status should be changed to Green and the Action closed.

Issues List

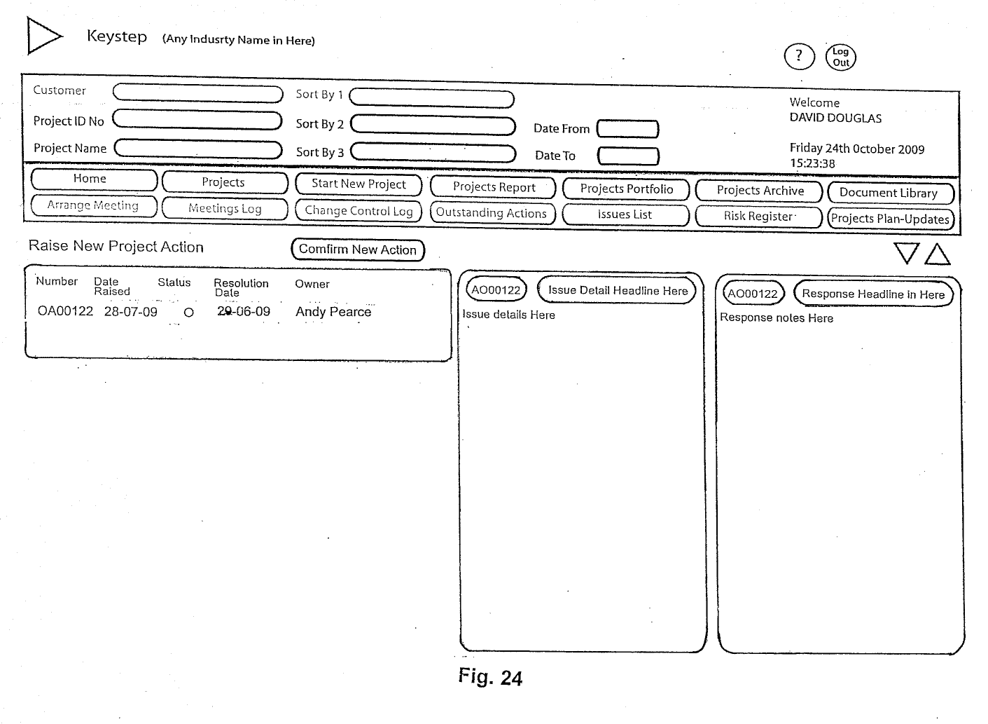

Selecting the Issues List link on the user interface opens a new window, shown in FIG. 24. The window includes an issues list table that preferably includes the following table columns; issues reference number, date raised, resolution date, issue details, response, owner and date closed. The user can click on the issues details and response cells for more details. Preferably, the issues list can be scrolled up or down using the scroll arrows.

A button, labelled ‘new’, is available to the user in order to create a new issue. In addition to recording the details listed above, the user defines which task or phase the issue is to be associated with. The association with a specific, time-limited task or phase (known within the invention as ‘pinning’), allows the system to maintain the correct display for the colour status indicators, of both the individual issue and the associated task or phase.

Raising a Project Issue

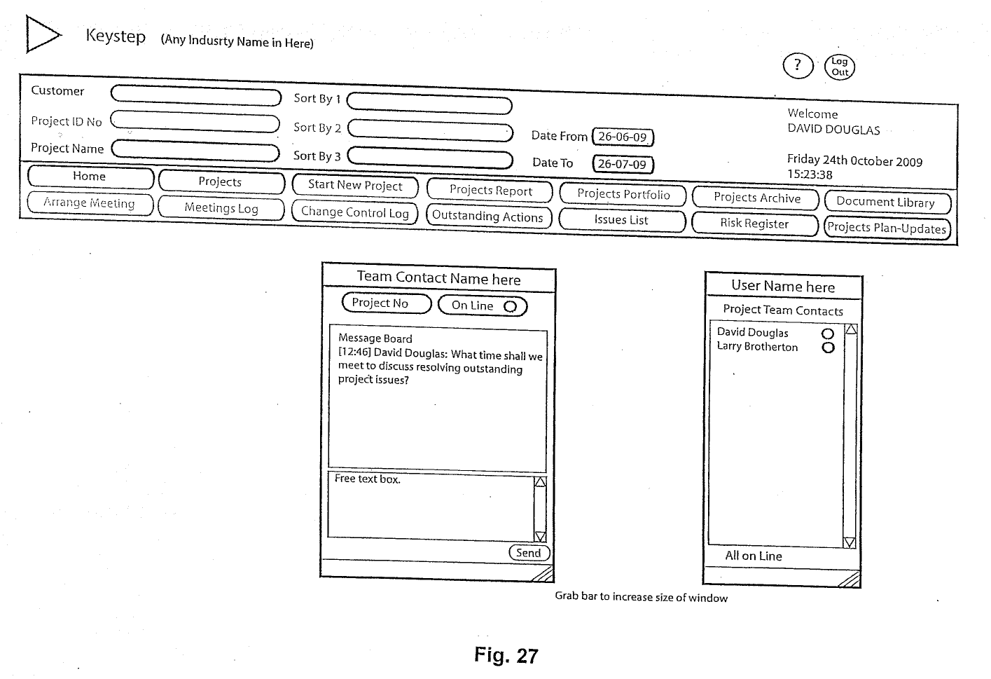

A Project Issue is raised by project personnel, using the view illustrated in FIG. 27, when they become aware of an item that the project needs to overcome to progress. If the Issue is raised by a member of the team who does not have the security clearance to write directly to the Issues List, the Issue will be given a status of ‘Pending Acceptance’ and an Outstanding Action created, linked to the Issue, for the Project Manager to approve entry to the Issues List. Once the Outstanding Action is approved by the Project Manager, the status of the Issue is changed to Accepted. The Issue will be pinned to a specific project Phase, Task or Document. When the Quality Gate that includes the pinned Issue is reached, it should not be possible for the Project Manger to close the Quality Gate until the Issue has been successfully resolved, when the RAG status should be changed to Green and the Issue closed.

Risk Register

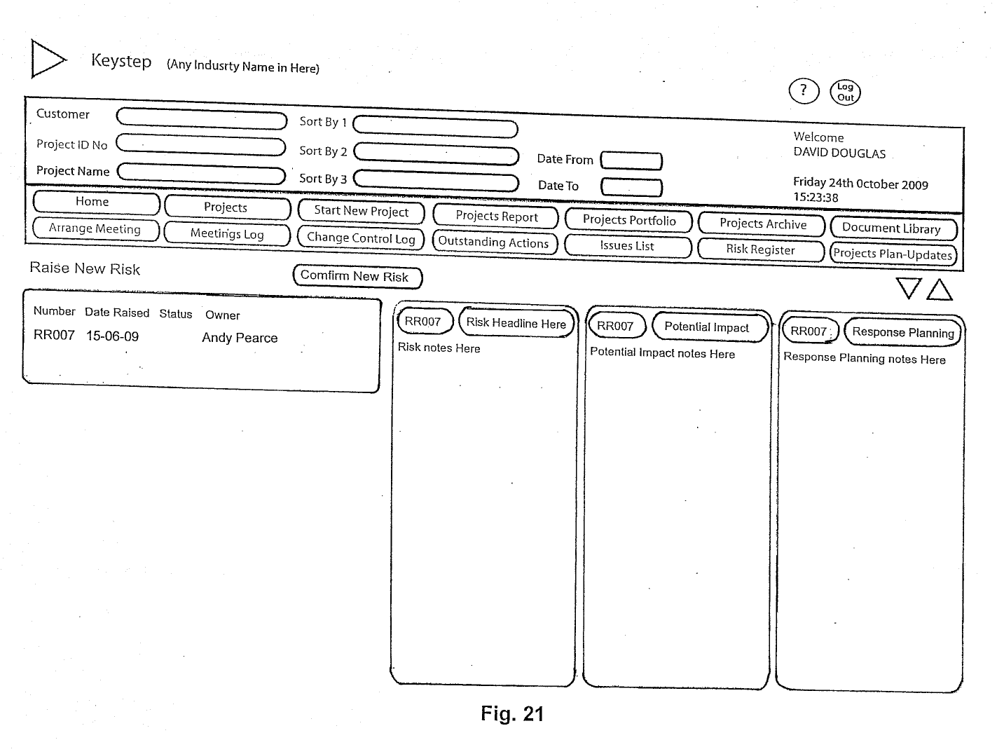

Selecting the risk register link on the user interface opens a new window, shown in FIG. 21. The window includes a risk register log table that advantageously includes the following table columns; risk reference number, date raised, status, owner, risk, potential impact to project, response planning and date closed.

A user can select the risk, potential impact to project and response planning cells for more details. The risk register log can be scrolled up or down using the scroll arrows.

A button, labelled ‘new’, is available to the user in order to create a new risk. In addition to recording the details listed above, the user defines which task or phase the risk is to be associated with. The association with a specific, time-limited task or phase (known within the invention as ‘pinning’), allows the system to maintain the correct display for the colour status indicators, of both the individual risk and the associated task or phase.

Recording a Project Risk

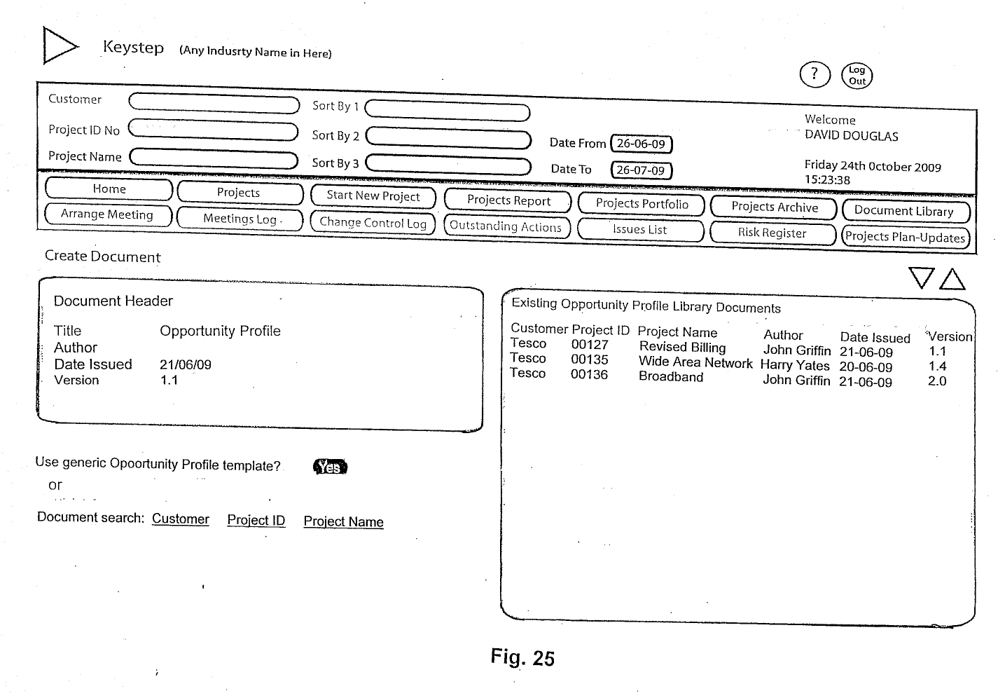

A project Risk is raised by project personnel, using the view illustrated in FIG. 25, when they become aware of an item that would, if it occurred, result in an issue for the project to overcome. If the Risk is raised by a member of the team who does not have the security clearance to write directly to the Risk Register, the Risk will be given a status of ‘Pending Acceptance’ and an Outstanding Action created, linked to the Risk, for the Project Manager to approve entry to the Risk Register. Once the Outstanding Action is approved by the Project Manager, the status of the Risk is changed to Accepted. The Risk will be linked to one or more project Phases, Task or Documents. By their very nature, some Risks exist for most of the duration of the project and will, therefore, be pinned to more than one Phase. When a Quality Gate is reached, it should be possible for the Project Manger to make an input to the Quality Gate to indicate that the Risk has been successfully mitigated for that particular Phase, and should not prevent the closure of the Quality Gate. Under these circumstances, the Risk is carried forward to the subsequent Phase. Upon the successful mitigation of the project Risk for the last pinned Phase, the RAG status of the Risk should be changed to Green and the Risk closed.

Project Plan & Updates

Selecting the project plan link on the user interface opens a new window, shown in FIG. 33.

If no plan is available, a plan based on a template stored in the database may be imported from another source, such as a Microsoft Project™ file, using the provided interface program (illustrated in FIG. 38). The interface program provides import and export facilities for Project files. The import allows the upload and display, on the user interface, of an external project plan, and the export allows the current project plan to be exported in Microsoft Project™ file format, for display within that program.

A user selects the ‘Import Project Plan’ button and specifies the location of the target file for import. After clicking the ‘Start Import’ button, the user will see a message to confirm that the import has been successful. The plan may now be viewed through the project plan screen illustrated in FIG. 33. If the import has failed, a message will be displayed with the reason, which must be corrected before attempting the import again.

The current project plan may be exported from the database to be viewed in an external program. To achieve this, the user selects the ‘Export Project Plan’ button and specifies the location for saving the file. After clicking the ‘Start Export’ button, the user will see a message to confirm that the export has been successful. The plan may now be viewed using the external program. If the export failed, a message will be displayed with the reason, which must be corrected before attempting the export again.

Help

The screen header section preferably includes a link to a Help view (illustrated in FIG. 34). A user selecting the Help link will be offered in-context help information in a pop-up window, with an option to navigate to and open sections of the overall user guide, which offers the user a walk-through manual on how to deliver a project using the system. The system administration software suite provides facilities to maintain all help displays.

Maintain Project Schedule

A user with the appropriate security settings can maintain project schedules. The user will select the appropriate project and, from within the Internal Project view, use the ‘Project Plan & Updates’ navigation button to select the project schedule. The Project Schedule display (illustrated in FIG. 33) shows a list of project tasks with the start and finish dates and the task duration against each task (in the first instance the start and finish dates are populated using the default values from the appropriate Industry Sector Template) and the name and project role of the person allocated to complete the task. The user may amend the project schedule dates, as required, but cannot change scheduled dates that are in the past.

Subscriber User Maintenance

When an organisation subscribes to the system, via a public internet website, the subscription sign-up process includes the recording of a Forename, Surname, Organisation Role and e-mail address for a Lead Contact. The Lead Contact is then responsible for the subsequent set-up of the other subscriber users within the organisation, and therefore controls the organisation's expenditure on the system. Details for other users can be added by the Lead Contact via the website, when completing the subscription sign-up, or can be added subsequently using the Subscriber User Maintenance view (illustrated in FIG. 35) The completion of the sign-up process via the website also raises an Outstanding Action for the Lead Contact to nominate one of the Organisations other personnel as a deputy for administration purposes and add the appropriate personal details.

It is also possible for a user with the appropriate security profile, for example, a Project Manager, to add details of organisation personnel whilst allocating staff to work on a project, but these will not become live system users until the Lead Contact has approved them (see below for details).

Authorise New Subscriber Personnel

The Lead Contact is required to authorise systems access for new personnel that have been added at project/task level by personnel with the appropriate security levels. When clicking on the appropriate Outstanding Action, a list of the new personnel is displayed (illustrated in FIG. 40), for the Lead Contact to make input to indicate authorisation of the personnel, with options on the screen to approve the names individually or all at once. Clicking on an individual name will allow editing of the personnel details, via the subscriber personnel maintenance view (illustrated in FIG. 36). Once the authorisation input is complete, and before the database is updated, a summary screen is displayed to confirm the number of personnel to be added and the associated monthly cost being approved (the calculation is made via reference to the current subscription rates within the database). The Lead Contact confirms approval of the changes. As the system displays all names for approval when the Outstanding Action is clicked, it is only necessary to maintain one Outstanding Action for all new personnel awaiting approval by the Lead Contact. A confirmation e-mail is sent to each of the new subscriber users, welcoming them to the system, advising their system password and requesting that they log on to review the personal details stored on the system.

Subscriber Personnel Maintenance

Personal details added by the Lead Contact may be accessed and amended by the individuals concerned. The first time a user logs into the system, they are presented with the Subscriber Personal Details view (illustrated in FIG. 36), in order to verify and/or amend the existing information. If the overall design of the system requires more information to be available before further use of the system by the individual, it will be made mandatory at this point. If the user closes the view without completing the necessary data, the associated functionality will not be available and the view will be presented the next time the user logs on, and ad infinitum until the necessary details have been completed and saved.

Template Management

The Lead Contact is also responsible for defining which template version(s) should be available for use by the organisation's personnel. Using the template management view (illustrated in FIG. 37), the Lead Contact can view the structure of each available template and make input to indicate which template versions should be available. It should be possible to define a future date for the use of a template for new projects to commence and, similarly, it should also be possible to define a future date for the use of a template for new projects to cease. NB—the above does not imply deletion of any template records—these actions are logical deletes only, as ‘ceased’ template records are required for viewing closed projects within the archive. In addition, the Lead Contact can set parameters controlling the Project ID start number (the user should be prompted to set this when the first project is started and it cannot be amended subsequently) and the next Project ID number, which is maintained automatically in sequence, by the system, but can be amended, to a higher number only, at any time

Maintain Project Team

Users with the appropriate security settings can maintain the allocation of personnel to projects. The user selects the appropriate project and, from within the Internal Project View screen, clicks on the personnel icon on the appropriate lower level process task to populate information (i.e. the minimum information required is Forename, Surname, e-mail address—the organisation role is assumed from the role allocated to the task on the Industry Sector Template and automatically added. During the allocation the information display can be expanded to show the entire project team, via the maintain project team view (illustrated in FIG. 39). It is also possible to allocate personnel to tasks using the ‘Project Plan & Updates’ navigation button to select the Project Schedule display. The Project Schedule display shows a list of project tasks with the start and finish dates, the task duration against each task and the name and project role of the person allocated to complete the task.

If nobody has been allocated to complete a specific task, the name field will be blank and the project role populated by the default value from the appropriate Industry Sector Template. For organisations where only one person is currently allocated to a role, this name should be used to automatically populate all projects. The user may amend the project personnel allocation, as required; the system should allow for any number of personnel to be allocated to a role during a project. The method for this should be to have a button/tickbox (positioned adjacent to the name display for the current allocation) to allocate a new person to the task, via a dropdown list. The dropdown should be populated with the names of personnel who have been allocated to the same role previously at the top (sorted by surname alpha), followed by all other organisation personnel (sorted by surname alpha). An option to ‘Add New Name’ should be included within the drop-down, positioned after the names of personnel who have been allocated to the same role previously and before the remaining organisation personnel names. The user will be prompted to input the effective date of the allocation and the system will create a new role allocation record, with this date in the Start Date field. The End Date field of the previous role allocation record will be populated with the date of the day before this new allocation effective date. If the person to be allocated to the task is not currently on the system, the user (who must have the appropriate security level) selects the ‘Add New Name’ option from the drop-down and enters the minimum details required for new personnel (i.e. Forename, Surname, e-mail address—the organisation role is assumed from the role allocated to the task on the Industry Sector Template). An Outstanding Action is created for the Lead Contact to authorise the addition of the new person and the person will not be able to log into the system until the Lead Contact has approved the input (this is to provide a single point of control for the monthly subscription charges).

Subscriber Supplier Maintenance

A subscriber organisation may optionally involve one or more of its suppliers in its projects. There are two levels of Subscriber Supplier Users; Lead Supplier (the single point of contact) and Supplier. There may be multiple Supplier users, of which one may be nominated as a deputy for the Lead Supplier. Subscriber Supplier Users are subject to the same access and security rules and maintenance procedures as the Subscriber Users. In common with the initial Subscriber User record (the Lead Contact), the first Subscriber Supplier User record (the Lead Supplier) requires a check to ensure that the appropriate Organisation record exists, as the input must include the organisation details if they are not currently available. The Subscriber Supplier Maintenance view (illustrated in FIG. 41) is accessed from within the Subscriber User Maintenance view (illustrated in FIG. 35).

Subscriber Customer Maintenance

A subscriber organisation may optionally involve one or more of its customers in its projects. There are two levels of Subscriber Customer Users; Lead Customer (the single point of contact) and Customer. There may be multiple Customer users, of which one may be nominated as a deputy for the Lead Customer. Subscriber Customer Users are subject to the same access and security rules and maintenance procedures as the Subscriber Users. In common with the initial Subscriber User record (the Lead Contact), the first Subscriber Customer User record (the Lead Customer) requires a check to ensure that the appropriate Organisation record exists, as the input must include the organisation details if they are not currently available. The Subscriber Customer Maintenance view (illustrated in FIG. 42) is accessed from within the Subscriber User Maintenance view (illustrated in FIG. 35).

Subscriber Screen Report Generator

A single Screen Report Generator view (illustrated in FIG. 43) will provide access to all Subscriber reports, via a dropdown list of available reports. The system security will ensure that, when Subscribers access the Report Generator, the dropdown list is filtered to display only Subscriber reports (i.e. no Administrative reports). If output to a printer is required, this can be selected from the screen display.

Create Document

Documents can be complex in structure (for example, a system design document), consisting of header details, a table of contents, associated paragraphs and sub-paragraphs and appendices (for example, containing diagrams), or can be simple in structure, consisting of a single page with header details and some text (for example, a process instruction). One of the main objectives of the system is to provide consistency and increase quality and efficiency, through the utilisation of templates specifically designed for each project type. The initial creation process (illustrated in FIG. 44) allows the choice between the use of a generic document template, or the re-use of a completed document created by a previous project and stored in the Document Library (see below).

During the creation of a document the author indicates the completion of individual sections, thereby providing additional business insight from the system regarding progress. A flexible approach of ‘skipping’ sections that are not required for specific projects allows consistent document structures to be maintained, as well as removing any ambiguity regarding content that has potentially been missed out.

Document Library

Once started, documents are available within the document library (illustrated in FIG. 45), to be shared with other project team members for reference, review or collaboration on content. The different types of document are indicated and searches may be performed using a variety of criteria.

Instant Messaging

When available in the legend bar, the instant messaging view (illustrated in FIG. 46) can be selected to provide text communication facilities. A contacts list, consisting of project team members only, is available, with an indication of which members of the project team are currently logged in, and therefore available for communication.

Administrative Software Functions

Administrative User Maintenance

Personnel logging in under the Administrative User roles are responsible for:
Creating and maintaining the system control parameters
Inputting and maintaining system standing data
Producing and analysing management reports
Investigating and resolving issues reported regarding the operation of the system

There are four levels of Administrative User—System Super User, System Admin, System Audit and Subscriber Audit. The System Super User is responsible for the creation and maintenance of these four user profiles.

The User ID field input should not be case sensitive, but the associated Password field should be case sensitive and an appropriate warning message displayed if an attempted login is failing due to the case condition of the input. It is not be possible to delete all System Super Users and the action should be prohibited and a warning message displayed if an attempt is made to delete the last remaining System Super User.

In common with all user records, the Administrative User Maintenance view (illustrated in FIG. 47) allows the recording of personnel information, for example, forename, surname, organisation, organisation role, e-mail address 1, e-mail address 2, work phone number 1, work phone number 2, mobile phone number 1, mobile phone number 2, home phone number and full address details.

Maintain System Control Parameters

The Maintain System Control Parameters view (illustrated in FIG. 48) allows control of both global system and subscriber organisation control parameters.

Global System Control parameters are available as follows:
Callback Notification E-mail Address(es)—one or more e-mail addresses to send notification e-mails to when a Callback request is submitted to the website.

Subscriber Organisation System Control parameters are required as follows:
Display owner logo on screens? (Y/N—default is Y)
Display Subscriber organisation logo on screens? (Y/N—default is Y)
Default version of industry sector template in use (allows the subscriber to use a specific version of the template)
Available versions of the industry sector template (allows the subscriber to define which alternative versions of the template should be available to project managers)

Maintain System Standing Data

If appropriate to the overall design of the system, various types of standing data may be updated via the Maintain System Standing Data view (illustrated in FIG. 49). The type of update (for example, create, update, read and delete) available in any instance is determined by the access rights and security profile of the logged in administration user. Standing data has a) a start date, from which the data will be available to the appropriate users and b) an end date, after which subscribers will not be able to use the data for new projects. Full integrity is maintained for standing data, i.e. it is not possible to physically delete standing data that has been recorded on a project. Facilities are available for the update of the following:
Reason Codes [for type ‘How Heard About Us’] (personal recommendation, received e-mail, web search engine, exhibition, meeting, business magazine, daily newspaper, Sunday newspaper, telephone contact)

Subscriber Specific Data Storage Requirements
Subscriber logo (graphics file)
Contact Log Report
Outstanding Actions Report

Investigating and Resolving Issues

Administration staff will use the user login with the appropriate access privileges in order to investigate and resolve issues reported by users. The results of any investigation may require subsequent access and update of other areas of the system, for example, the Issues List (illustrated in FIG. 24), the Software Issues Log (illustrated in FIG. 54) and the Known Issues Log (illustrated in FIG. 57).

Maintain Industry Sector Template

An industry sector template has a two-tiered hierarchical structure, consisting of (top down) phases in the upper level and tasks/documents in the lower level. The Maintain Industry Sector Template function (illustrated in FIG. 50) allows the creation and subsequent maintenance of Industry Sector Templates. It is possible to store multiple versions of an Industry Sector Template with the same name—the system automatically maintains a separate version number for each variation of the template. The definition of each template includes:
The Industry Sector Template name
The template version number (automatically generated)
A template text description (optional)
A start date for the template to be available to the appropriate users
An end date, after which subscribers will not be able to use the template for new projects
A graphic file for a logo to be associated with a template version (optional)
For Phases:
   The number of Phases in the upper hierarchical level
   The name of each Phase
   The position of each Phase relative to the other Phases (phases are sequential and cannot overlap). This should be done in a single process where all Phases are visible.
For Tasks/Documents:
The number of Tasks/Documents in the lower hierarchical level of each Phase
The name of each Task/Document
The position of each Task/Document relative to the other Tasks/Documents in the Phase (by defining the preceding Task/Document, Blank=first task in a Phase). This should be done in a single process where all Task/Documents within a Phase are visible.
The default time required to complete each Task/Document (in full or partial working days). When all Tasks/Documents for a Phase have been defined the default elapsed time for the Phase can be calculated.
   The role responsible for completing each Task/Document
   A flag against each Task/Document to indicate whether the role responsible should be visible (to Customer Subscribers) within the External Project View. If not, the role that is to replace it should be selected from a drop down (default value is Project Manager).

When creating an alternative version of an existing industry sector template, the structure is recorded as a new version of the template. Full integrity is maintained between the previous version(s) and any projects that they were utilised for. The template version number is visible on-screen to users, for identification purposes.

Changes to the structure (i.e. number of phases, tasks or documents) of an existing industry sector template are also recorded as a new version of the template, with start and end dates. Full integrity is maintained between the previous versions and any projects that they were utilised for. The template version number is visible on-screen to users, for identification purposes.

Subscriber Organisation Maintenance

The Subscriber Organisation Maintenance view (illustrated in FIG. 51) allows the definition and subsequent maintenance of a subscriber organisation. The same information will also be recorder for subscriber organisations registering via the public internet website, through the functionality for integration with the system (see below).

It is possible to record multiple contacts and address details for an organisation. In the case of a single contact being recorded, the Role Type recorded is automatically allocated as Lead Contact. If multiple contacts are recorded, the Role Type of Lead Contact is allocated automatically to the first recorded contact. Similarly, in the case of a single address being recorded, the Role Type recorded is allocated automatically as Primary Location. If multiple addresses are recorded, the Role Type of Primary Location is allocated automatically to the first recorded address. The Lead Contact and Primary Location flags are amendable.

Optionally, a Subsidiary Organisation (an Organisation record that has a parent Organisation record) may also be recorded. The main purpose of this is to allow the presentation of different Organisation identities for projects, but a single contact and/or a single billing address for the related organisations. The collective name for an organisation with subsidiaries is a Group Organisation.

A payment record is also maintained for a subscriber organisation.

Administration Screen Report Generator

The Administration Screen Report Generator view (illustrated in FIG. 52) is the same as the Subscriber Screen Report Generator, but the security software allows access to a greater range of reports, via the dropdown list. If output to a printer is required, this can be selected from the screen display.

Data Loader

Software functionality is available for the direct loading of bulk standing data (illustrated in FIG. 53). The sources of the bulk load may be, for example, the provision of a custom software tool, the import of data from a Microsoft Excel spreadsheet or delimited file format (e.g. a .csv file) or provision of any other suitable tool that is proven to work with the database.

Software Issues Log

The software issues log (illustrated in FIG. 54) is a subset of the main issues log, dedicated to monitoring issues associated with software development, and is only available to users logging in as System Administrators. Inclusion within the software issues log is indicated by specifically marking issue records when they are created. Additional information is, for example, whether a software issue affects core business functionality, non-core functionality or is just a cosmetic issue. System Super User and System Admin logins should be able to create, read, update and delete records; System Audit and Subscriber Audit logins should only be able read records.

Outstanding Issues Log

If an item on the Contact Log (see below) is flagged for action (optional), an item should be created automatically on the Outstanding Issues Log (illustrated in FIG. 55), for the system administrator to action, complete and close.

Integration With the Public Internet Website

Managing Customer Contacts

Customer Contacts, e.g. requests to join newsletter, e-mail and postal lists and callback requests, are managed using the Contact Log (illustrated in FIG. 56). The details required to satisfy the contact request (for example, name, phone numbers and e-mail and postal addresses) are recorded when a) a contact request is submitted to the public internet website or, b) a direct entry is made to the Contact Log. Items on the Contact Log can be flagged for a follow-up action, in which case a new item is created on the Outstanding Issues Log.

Request Callback

This function is used to record contact details of potential subscribers and other interested parties, in order to make a return phone call. When the information necessary to satisfy the callback request is recorded the user is asked if the telephone number is their normal telephone contact number. If it is not, it is recorded as a temporary contact phone number on the Contact table and the user is asked to enter (optional) their usual contact number(s). Market research information is gathered by asking the user to indicate [from a drop-down list] how they heard about the service. Details of when the request was submitted and the preferred callback time are recorded. The completion of the callback request by the user should trigger the sending of an e-mail to the e-mail address(es) recorded within the appropriate system configuration parameter

Types of Contact Notification is an automatic system function to be triggered by a Callback Request being submitted to the public internet website. Upon receipt of the Callback Request, an e-mail is sent to the address(es) stored within the [Callback Notification E-mail Address(es)] system configuration parameter containing—preferred callback time (UK time & local time), phone number to call, country, forename, surname, organisation role, organisation, how heard about PMS, time/date request submitted & comments.

Known Issues Log

The known issues log (illustrated in FIG. 57) is a subset of the Software Issues Log, dedicated to keeping subscribers informed of current software issues under investigation, and is available to all subscriber users via the public internet site. The items for display are specifically marked for inclusion within the Known Issues Log.

What is claimed is:

1. Apparatus in a system, the system including at least one database, one of the at least one database configured to store one or more templates, and a user device including a user interface for receiving user input, the apparatus comprising:
a) a retriever to retrieve at least one of the one or more templates from the at least one database, in response to user input into the user device
b) a first output to transmit the retrieved template to the user device
c) an input to receive an adapted template from the user device, the adapted template comprising the template and user input, and
d) a second output to transmit the adapted template to one of the at least one databases.

2. Apparatus as claimed in claim 1 wherein the one or more templates comprises a project template, the project template defining a project including project phases and tasks, the amended project template comprising project phases and tasks selected according to the user input.

3. Apparatus as claimed in claim 2 wherein the apparatus is configured to segregate data into the project phases according to information received from the user device.

4. Apparatus as claimed in claim 2 wherein each project phase includes one or more tasks which are pre-assigned to the project phase.

5. Apparatus as claimed in claim 2 wherein one of the group consisting of a phase and a task is assigned a weighting, the weighting being correlated with the importance of the one of the group.

6. Apparatus as claimed in claim 5 wherein the weighting of the one of the group consists of at least one of: the length of time overdue, the amount of work outstanding, the project value, the contribution to project gross profit and the customer value.

7. Apparatus as claimed in claim 1 wherein the amended template is stored in one of the at least one databases such that the retrieval component can retrieve the amended template in response to user input into the user device

8. Apparatus as claimed in claim 2 wherein a phase comprises one or more quality gate checkpoints, each quality gate checkpoint being configured to control completion of the phase dependent upon a) each individual task within a phase being completed and b) outputs created during each task being accepted.

9. Apparatus as claimed in claim 7 wherein the apparatus enables the next phase to be implemented only when the quality gate checkpoint for the preceding phase has been completed.

10. Apparatus as claimed in claim 2 wherein the apparatus is configured to transmit project data, to the user device, the project data causing a graphical display of at least one of the group comprising a project phase, a task and a quality control gate on the user interface of the user device.

11. Apparatus as claimed in claim 10 wherein the project data includes data representing at least one of a) an implementation phase, b) task detail and c) a task deliverable.

12. Apparatus as claimed in claim 11 wherein the graphical display comprises data representing the progress of process workflow and document production, for multiple projects using coloured indicators.

13. Apparatus as claimed in claim 12 wherein the coloured indicators have separate colours indicating that the process phase not started, a task is in process, a task is on time, a task is suffering delay and the target date has not been met.

14. Apparatus as claimed in claim 1 wherein the one or more templates comprises a document template, the document template comprising text.

15. Apparatus as claimed in claim 14 wherein the document template comprises a plurality of sections, one or more of the plurality of sections being a mandatory section, the apparatus being configured to ensure that the mandatory section is completed in the amended template before transmitting the amended output to one of the databases.

16. Apparatus as claimed in claim 14 wherein the document template comprises a number of alternative sections and the apparatus, is further configured to receive initial user input and retrieve one or more or the alternative sections of the document template in response to receiving initial user input.

17. Apparatus as claimed in claim 15 wherein a section of a document comprises intelligent data, intelligent data being data to be automatically copied between one or more documents and/or project phases in the project.

18. A system comprising at least one database, one of the at least one database configured to store one or more templates, a user device including a user interface for receiving user input, and an apparatus comprising:
a) a retrieval component to retrieve at least one of the one or more templates from the at least one database, in response to user input into the user interface
b) a first output to transmit the retrieved template to the user device
c) an input to receive an adapted template from the user device, the adapted template comprising the template and user input, and
d) a second output to transmit the adapted template to one of the at least one databases.

19. A computer program embodied on a computer readable medium, the computer program configured to cause an apparatus in a system, the system including at least one database, one of the at least one database configured to store one or more templates, and a user device including a user interface for receiving user input, to perform the steps of:
a) retrieving at least one of the one or more templates from the at least one database, in response to user input into the user interface
b) transmitting the retrieved template to the user device
c) receiving an adapted template from the user device, the adapted template comprising the template and user input, and
d) transmitting the adapted template to one of the at least one databases.
